(19) United States
(12) Patent Application Publication
(10) Pub. No.: US 2026/0239182 A1
(43) Pub. Date: Aug. 13, 2026

(54) SYSTEM INFORMATION DOWNLOAD

(71) Applicant: QUALCOMM Incorporated, San Diego, CA (US)

(72) Inventors: Jianhua LIU, Beijing (CN); Ozcan OZTURK, San Diego, CA (US); Gavin Bernard HORN, La Jolla, CA (US); Hong CHENG, Basking Ridge, NJ (US); Miguel GRIOT, La Jolla, CA (US); Karl Georg HAMPEL, Jersey City, NJ (US)

(21) Appl. No.: 19/522,658

(22) PCT Filed: Dec. 7, 2023
(86) PCT No.: PCT/CN2023/137100

§ 371 Date: Mar. 24, 2026

(51) Int. Cl. H04W 48/16

(52) U.S. Cl. CPC H04W 48/16

(57) ABSTRACT

A user equipment (UE) transmits, to a network node, a request for system information associated with a system information service for a wireless network. The UE receives, via the network node, the system information from the system information service for the wireless network. A network node obtains a request for system information for a UE and provides the request for the system information to a system information service for a wireless network. The network node receives the system information from the system information service in response to the request and provides the system information from the system information service for the UE.

### INTRODUCTION

The present disclosure relates generally to communication systems, and more particularly, to wireless communication including the transmission and reception of system information.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In some aspects, the techniques described herein relate to an apparatus for wireless communication at a user equipment (UE), including: one or more memories; and one or more processors coupled to the one or more memories and configured to cause the UE to: transmit, to a network node, a request for system information associated with a system information service for a wireless network; and receive, via the network node, the system information from the system information service for the wireless network.

In some aspects, the techniques described herein relate to a method of wireless communication at a UE, including: transmitting, to a network node, a request for system information associated with a system information service for a wireless network; and receiving, via the network node, the system information from the system information service for the wireless network.

In some aspects, the techniques described herein relate to an apparatus for wireless communication at a UE, including: means for transmitting, to a network node, a request for system information associated with a system information service for a wireless network; and means for receiving, via the network node, the system information from the system information service for the wireless network.

In an aspect of the disclosure, a computer-readable medium is provided. The computer-readable medium stores computer executable code at a UE, the code when executed by one or more processors causes the UE to: transmit, to a network node, a request for system information associated with a system information service for a wireless network; and receive, via the network node, the system information from the system information service for the wireless network.

In some aspects, the techniques described herein relate to an apparatus for wireless communication at a network node, including: one or more memories; and one or more processors coupled to the one or more memories and configured to cause the network node to: obtain a request for system information for a UE; provide the request for the system information to a system information service for a wireless network; receive the system information from the system information service in response to the request; and provide the system information from the system information service for the UE.

In some aspects, the techniques described herein relate to a method of wireless communication at a network node, including: obtaining a request for system information for a UE; providing the request for the system information to a system information service for a wireless network; receiving the system information from the system information service in response to providing the request; and providing the system information from the system information service for the UE.

In some aspects, the techniques described herein relate to an apparatus for wireless communication at a network node, including: means for obtaining a request for system information for a UE; means for providing the request for the system information to a system information service for a wireless network; means for receiving the system information from the system information service in response to providing the request; and means for providing the system information from the system information service for the UE.

In an aspect of the disclosure, a computer-readable medium is provided. The computer-readable medium stores computer executable code at a network node, the code when executed by one or more processors causes the network node to: obtain a request for system information for a UE; provide the request for the system information to a system information service for a wireless network; receive the system information from the system information service in response to the request; and provide the system information from the system information service for the UE.

In some aspects, the techniques described herein relate to an apparatus for wireless communication at a network node, including: one or more memories; and one or more processors coupled to the one or more memories and configured to cause the network node to: obtain system information from a system information service; obtain a request for the system information for a UE; and provide the system information, for the UE, in response to the request, wherein the system information is obtained from the system information service prior to the request.

In some aspects, the techniques described herein relate to a method of wireless communication at a network node, including: obtaining system information from a system information service; obtaining a request for the system information for a UE; and providing the system information, for the UE, in response to the request, wherein the system information is obtained from the system information service prior to the request.

In some aspects, the techniques described herein relate to an apparatus for wireless communication at a network node, including: means for obtaining system information from a system information service; obtaining a request for the system information for a UE; and means for providing the system information, for the UE, in response to the request, wherein the system information is obtained from the system information service prior to the request.

In an aspect of the disclosure, a computer-readable medium is provided. The computer-readable medium stores computer executable code at a network node, the code when executed by one or more processors causes the network node to: obtain system information from a system information service; obtain a request for the system information for a UE; and provide the system information, for the UE, in response to the request, wherein the system information is obtained from the system information service prior to the request.

In some aspects, the techniques described herein relate to an apparatus for wireless communication at a system information service for a wireless network, including: one or more memories; and one or more processors coupled to the one or more memories and configured to cause the system information service to: receive a request for system information for a UE served by a network node; and provide the system information to the network node serving the UE in response to the request.

In some aspects, the techniques described herein relate to a method of wireless communication at a system information service for a wireless network, including: receiving a request for system information for a UE served by a network node; and providing the system information to the network node serving the UE in response to the request.

In some aspects, the techniques described herein relate to an apparatus for wireless communication at a system information service for a wireless network, including: means for receiving a request for system information for a UE served by a network node; and means for providing the system information to the network node serving the UE in response to the request.

In an aspect of the disclosure, a computer-readable medium is provided. The computer-readable medium stores computer executable code at a system information service, the code when executed by one or more processors causes the system information service to: receive a request for system information for a UE served by a network node; and provide the system information to the network node serving the UE in response to the request.

In some aspects, the techniques described herein relate to an apparatus for wireless communication at a system information service for a wireless network, including: one or more memories; and one or more processors coupled to the one or more memories and configured to cause the system information service to: obtain system information from one or more of a service for the wireless network or a radio node for the wireless network; and provide the system information from the system information service to one or more network nodes.

In some aspects, the techniques described herein relate to a method of wireless communication at a system information service for a wireless network, including: obtaining system information from one or more of a service for the wireless network or a radio node for the wireless network; and providing the system information from the system information service to one or more network nodes.

In some aspects, the techniques described herein relate to an apparatus for wireless communication at a system information service for a wireless network, including: means for obtaining system information from one or more of a service for the wireless network or a radio node for the wireless network; and means for providing the system information from the system information service to one or more network nodes.

In an aspect of the disclosure, a computer-readable medium is provided. The computer-readable medium stores computer executable code at a system information service, the code when executed by one or more processors causes the system information service to: obtain system information from one or more of a service for the wireless network or a radio node for the wireless network; and provide the system information from the system information service to one or more network nodes.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW), in accordance with various aspects of the present disclosure.

FIG. 2 shows a diagram illustrating architecture of an example of a disaggregated base station, in accordance with various aspects of the present disclosure.

FIG. 3A is a diagram illustrating an example of a first subframe within a frame structure, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second subframe within a frame structure, in accordance with various aspects of the present disclosure.

FIG. 3D is a diagram illustrating an example of uplink (UL) channels within a subframe, in accordance with various aspects of the present disclosure.

FIG. 4 is a block diagram illustrating an example of a base station in communication with a user equipment (UE) in an access network, in accordance with various aspects of the present disclosure.

FIG. 5A is a diagram illustrating an example function split between a core network and a RAN.

FIG. 5B is a diagram illustrating example aspects of a cloud native platform for a wireless network that may include a merger of core network and RAN services, in accordance with various aspects of the present disclosure.

FIG. 6 illustrates an example functional split between the core network and the RAN, in accordance with various aspects of the present disclosure.

FIG. 7A is a diagram showing RLC and/or MAC functions and PHY layer aspects separate from the services, in accordance with various aspects of the present disclosure.

FIG. 7B is a diagram that illustrates an example of addressing and routing for packet transport between a service and a UE via the RAN, e.g., including the eDU, in accordance with various aspects of the present disclosure.

FIG. 8A illustrates example aspects of uplink packet handling, in accordance with various aspects of the present disclosure.

FIG. 8B illustrates example aspects of downlink packet handling, in accordance with various aspects of the present disclosure.

FIG. 9 illustrates example aspects of an architecture for system information (SI) generation and delivery in a service based wireless network, in accordance with various aspects of the present disclosure.

FIG. 10 illustrates an example communication flow in which an SI service collects, stores, and generates SI, in accordance with various aspects of the present disclosure.

FIG. 11A is a diagram showing handling for an SI request for a connection based SI download from an SI service, e.g., over a user plane, in accordance with various aspects of the present disclosure.

FIG. 11B illustrates example aspects of SI download for delivery the SI to the UE as downlink information, in accordance with various aspects of the present disclosure.

FIG. 12 illustrates an example of a UE downloading SI over a user plane, in accordance with various aspects of the present disclosure.

FIG. 13 illustrates an example of an eDU obtaining SI for a UE, in accordance with various aspects of the present disclosure.

FIG. 14 illustrates an example of an ACMS obtaining SI for a UE, in accordance with various aspects of the present disclosure.

FIG. 15 illustrates an example communication flow 1500 for SI/SIB acquisition from an eDU, in accordance with various aspects of the present disclosure.

FIG. 16 illustrates an example in which a UE without an access connection includes the request in an L2 PDU, in accordance with various aspects of the present disclosure.

FIG. 17 is a flowchart of a method of wireless communication at a UE, in accordance with various aspects of the present disclosure.

FIG. 18 is a flowchart of a method of wireless communication at a network node, in accordance with various aspects of the present disclosure.

FIG. 19 is a flowchart of a method of wireless communication at network node, in accordance with various aspects of the present disclosure.

FIG. 20 is a flowchart of a method of wireless communication at an SI service, in accordance with various aspects of the present disclosure.

FIG. 21 is a flowchart of a method of wireless communication at an SI service, in accordance with various aspects of the present disclosure.

FIG. 22 is a diagram illustrating an example of a hardware implementation for an apparatus or a UE, in accordance with various aspects of the present disclosure.

FIG. 23 is a diagram illustrating an example of a hardware implementation for a network entity, in accordance with various aspects of the present disclosure.

FIG. 24 is a diagram illustrating an example of a hardware implementation for a network entity, in accordance with various aspects of the present disclosure.

FIG. 25 is a diagram illustrating an example of a hardware implementation for a network entity, in accordance with various aspects of the present disclosure.

### DETAILED DESCRIPTION

A wireless network may have a service based architecture that combines functions of a core network and a radio access network (RAN) node. The service based architecture may be provided on a cloud platform using application programming (API) interface. The services may provide various functions for the wireless network. Examples of services may include access control services, mobility services, public warning system (PWS) services, vehicle-to-anything (V2X) services, multicast and broadcast services (MBS) services, positioning services, and a system information (SI) service, among other examples. The service based architecture enables individual services hosted on the wireless network platform to be adjusted or upgraded independent of other services. The SI service, for example, may acquire SI input and/or system information blocks (SIBs) from various services that are a part of the wireless network, as well as from one or more radio nodes, which may be referred to as a distributed unit (DU) or an enhanced distributed unit (eDU), in some aspects. The SI service may collect and maintain the acquired system information input and may generate SI/SIBs that can be provided to one or more user equipment (UEs) served by the wireless network. The SI service may control the delivery mode of the SI/SIBs to the UEs. Examples of the delivery mode may include broadcast, on-demand in response to a request, and/or a user plane (UP) download, for example.

Aspects presented herein provide various procedures for SI acquisition in a wireless network having a service based architecture, which enables a more efficient use of system overhead through the targeted delivery of system information. For example, in contrast to the periodic broadcast of SI/SIB(s), aspects provide for the SI/SIB(s) to be provided to a UE in response to a request from the UE, which saves radio resources and enables added system efficiency with reduced system overhead. For example, the SI/SIBs can be provided in response to a UE request rather than reserving windows of wireless resources for the periodic broadcast of SI/SIBs. The targeted delivery to the UE is a more efficient use of wireless resource than a period broadcast of SI/SIBs and may enable an increase in a maximum number of SI or SIBs. The delivery of SI/SIB(s) in response to a UE request enables more granular control of SI/SIBs, for example, enabling SI/SIB(s) for different services to be independently updated. Aspects presented herein can also reduce UE power consumption because the UE can request particular SI/SIB(s) and may reduce or skip monitoring of periodic SI broadcasts. Aspects presented herein allow for improved security and added network control of access to SI/SIBs by enabling authentication and authorization of the UE for requested SI or SIBs before they are provided to the UE.

Alternatively, or additionally, a UE may send the request for particular SI or SIB(s) to the SI service in an internet protocol (IP) packet, and the UE may receive the requested SI/SIB(s) in an IP packet from the SI service. The request and delivery via IP packets enable transparent routing at an eDU, and enables the exchange to be made over the user plane (UP) without a control plane (CP) between the UE and the SI service.

In some aspects, the UE may send a request for one or more SI/SIBs to a network node such as an eDU or a core network service such as an access connection management service (ACMS). The network node may then request and receive the indicated SI/SIBs from the SI service via an API interface before providing the one or more SI/SIBs to the UE in response to the UE's request. In some aspects, the eDU or ACMS may maintain a subscription with the SI service.

Additionally, or alternatively, a network node, such as an eDU, may receive the SI/SIBs from the SI service prior to receiving a request from the UE. For example, the SI service may determine the SI/SIB(s) to be delivered from the eDU, and may provide the determined SI/SIBs to the eDU. When the eDU receives a request for a UE, the eDU may respond by sending the requested SI/SIB(s) that it previously received from the SI service. For example, the UE may request the SI/SIB(s) in a layer 2 (L2) protocol data unit (PDU) that it transmits to an eDU. The eDU may respond by sending the requested SI/SIB(s) in one or more L2 PDUs. The unicast delivery from a network node, such as an eDU, enables the SI/SIB(s) to be provided in response to a request for UEs (e.g., from UEs) that have an established connection or a request for UEs (e.g., from UEs) that are in an idle or inactive state without an established connection with the eDU.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

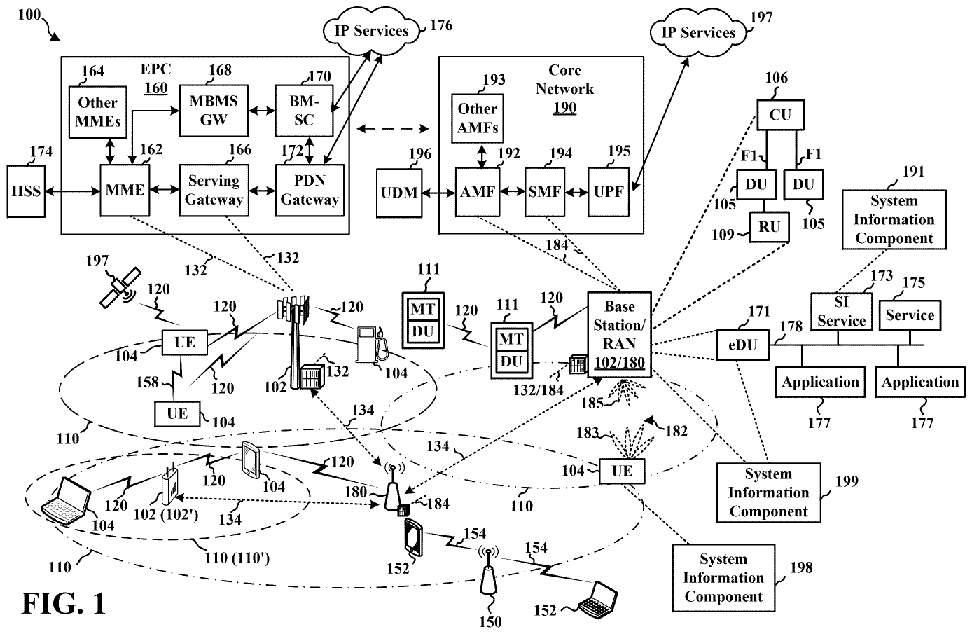

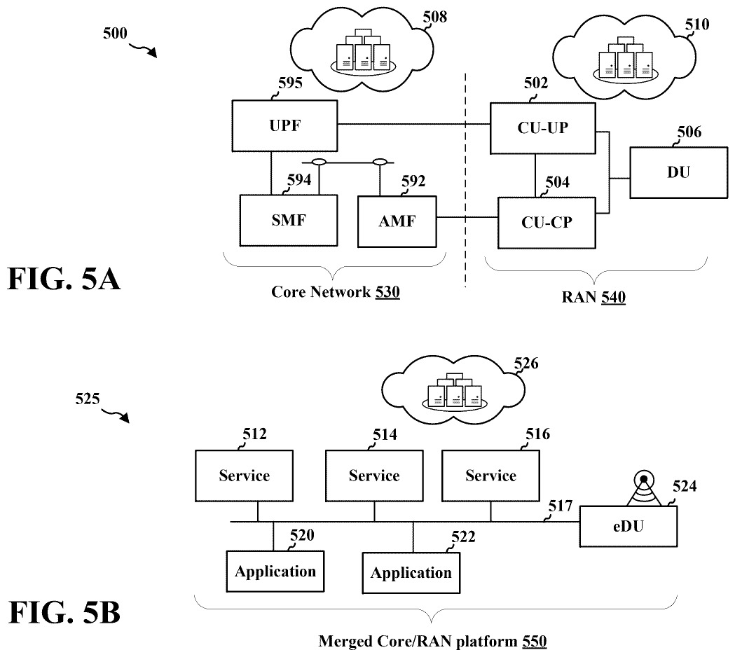

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). As presented herein, the wireless communication system may have a merged core network and RAN platform having a service based architecture on a cloud native platform, such as described in connection with any of FIGS. 5B, 6, 7A, 7B, 9, for example.

The radio node, which may be referred to as a base station 102, may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. The radio nodes configured for 6G, or other service based architectures, may have an API interface 178 with various services of the core network, such as described in connection with any of FIGS. 5B, 6, 7A, 7B, 9, for example. The service based architectures may include services, e.g., as represented by service 175 and SI service 173, and applications 177. FIG. 1 illustrates an eDU 171 as an example radio node, although such radio nodes may also be referred to as a DU, a network node, a network entity, or by other names.

In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN, or a radio node, and may include aggregated or disaggregated components. As an example of a disaggregated RAN, a base station or radio node may include a central unit (CU) (e.g., a CU 106), one or more DUs (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

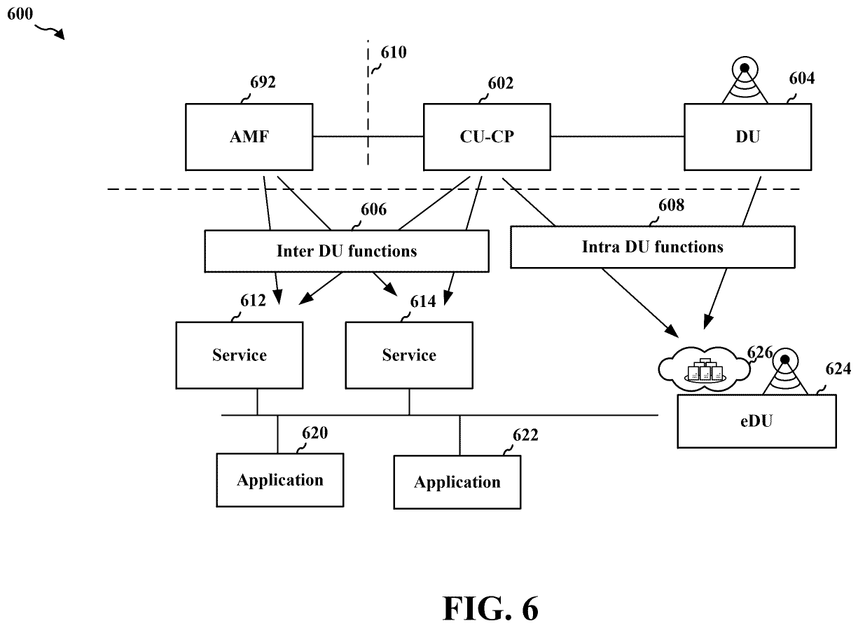

A different functional split may be provided for an eDU in a service based architecture, e.g., as described in connection with FIGS. 5B and 6.

The base stations 102, or radio nodes, may wirelessly communicate with the UEs 104. Each of the base stations 102 may provide communication coverage for a respective geographic coverage area 110. There may be overlapping geographic coverage areas. For example, a small cell may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR. Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2X or other D2D communication, such as Proximity Services (ProSe), etc.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell may operate in a licensed and/or an unlicensed frequency spectrum. When operating in an unlicensed frequency spectrum, the small cell may employ NR and use the same unlicensed frequency spectrum (e.g., 5 GHz, or the like) as used by the AP 150. The small cell, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell or a large cell (e.g., a macro base station), may include and/or be referred to as an eDU, a radio node, a network node, a network entity, an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 182 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 185. The UEs 104 may receive the beamformed signal from the base stations 180 in one or more receive directions 183. The UEs 104 may also transmit a beamformed signal to the base stations 180 in one or more transmit directions (e.g., 183). The base stations 180 may receive the beamformed signal from the UEs 104 in one or more receive directions (e.g., 185). The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, eDU, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, an eDU, and/or an RU. In some aspects, base stations, which may include disaggregated base stations and/or aggregated base stations, may be referred to as next generation (NG) RAN (NG-RAN). The base stations 102 provide an access point to a core network, such as the EPC 160, core network 190, and/or services 175 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the UE 104 may include a system information component 198 configured to cause the UE 104 to transmit, to a network node, a request for system information associated with a system information service for a wireless network; and receive, via the network node, the system information from the system information service for the wireless network.

A network node, such as a base station 102, 180, a component of a base station, or a radio node (e.g., a CU 106, DU 105, eDU 171, and/or RU 109) may include a system information component 199. In some aspects, the system information component 199 may be configured to cause the network node to obtain a request for system information for a UE; provide the request for the system information to a system information service 173 for a wireless network; receive the system information from the system information service in response to the request; and provide the system information from the system information service for the UE 104. In some aspects, the system information component 199 may be configured to cause the network node to obtain system information from a system information service; obtain a request for the system information for a UE 104; and provide the system information, for the UE, in response to the request, wherein the system information is obtained from the system information service prior to the request.

In some aspects, a system information service 173 may include a system information component 191. In some aspects, the system information component 191 may be configured to cause the system information service 173 to receive a request for system information for a UE 104 served by a network node; and provide the system information to the network node serving the UE in response to the request. In some aspects, the system information component 191 may be configured to cause the system information service 173 to obtain system information from one or more of a service 175 for the wireless network or a radio node for the wireless network; and provide the system information from the system information service 173 to one or more network nodes.

Deployment of communication systems, such as 5G NR systems or other communication systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

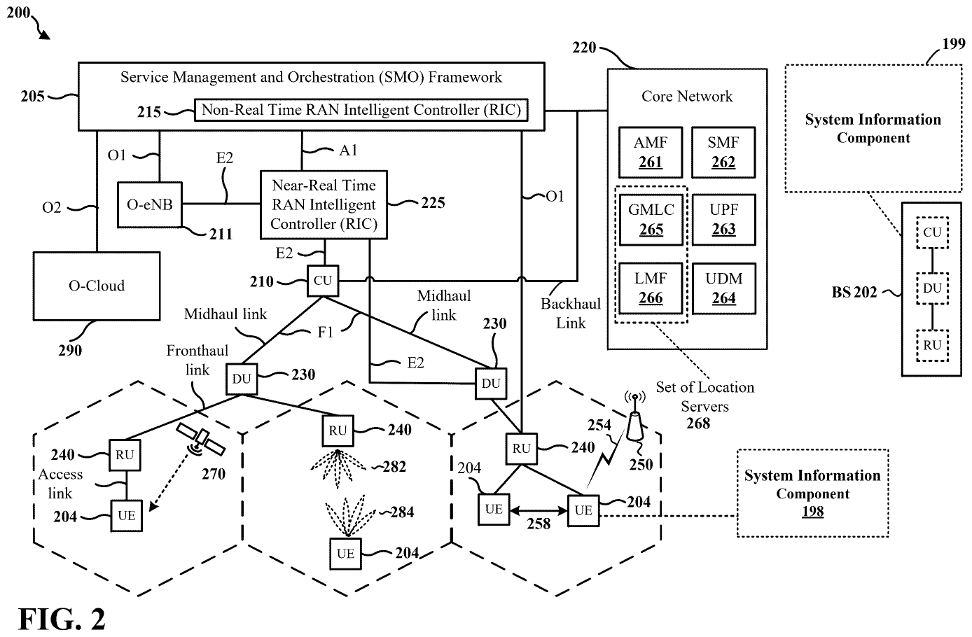

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUs.

Each of the units, i.e., the CUS (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 for the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in some aspects, the UE 204, similar for the UE 104 in FIG. 1, may include a system information component 198 configured to cause the UE 204 to transmit, to a network node, a request for system information associated with a system information service for a wireless network; and receive, via the network node, the system information from the system information service for the wireless network.

A network node, such as a base station 202 or a component of a base station (e.g., a CU 210, DU 230, eDU, and/or RU 240) may include a system information component 199. In some aspects, the system information component 199 may be configured to cause the network node to obtain a request for system information for a UE; provide the request for the system information to a system information service for a wireless network; receive the system information from the system information service in response to the request; and provide the system information from the system information service for the UE 104. In some aspects, the system information component 199 may be configured to cause the network node to obtain system information from a system information service; obtain a request for the system information for a UE 104; and provide the system information, for the UE, in response to the request, wherein the system information is obtained from the system information service prior to the request.

In some aspects, a system information service may include a system information component 191. In some aspects, the system information component 191 may be configured to cause the system information service to receive a request for system information for a UE 204 served by a network node; and provide the system information to the network node serving the UE in response to the request. In some aspects, the system information component 191 may be configured to cause the system information service to obtain system information from one or more of a service for the wireless network or a radio node for the wireless network; and provide the system information from the system information service to one or more network nodes.

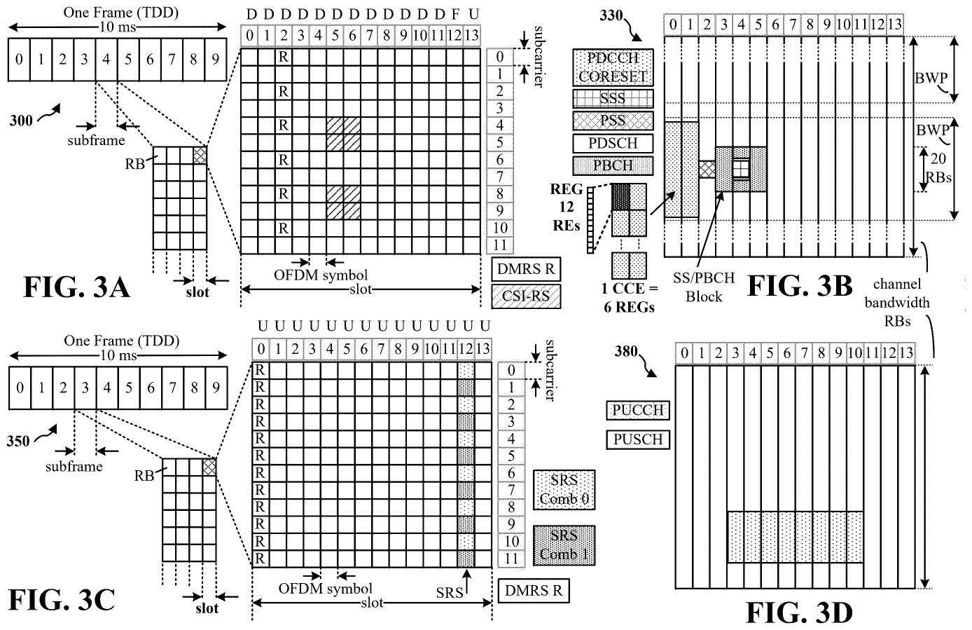

FIG. 3A is a diagram 300 illustrating an example of a first subframe within a frame structure. The example aspects may be for a 5G NR frame structure in order to illustrate an example radio frame having time and frequency resources. Aspects may also be applied for other wireless communication systems. FIG. 3B is a diagram 330 illustrating an example of DL channels within a subframe. FIG. 3C is a diagram 350 illustrating an example of a second subframe within a frame structure. FIG. 3D is a diagram 380 illustrating an example of UL channels within a subframe. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

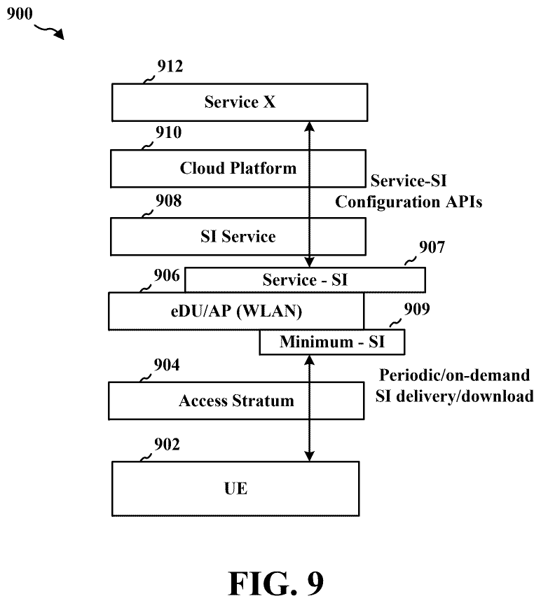

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages. As presented herein, a UE may request SI/SIB(s) associated with an SI service, and may receive the SI/SIB(s) in response to the request. In some aspects, a minimum SI may be provided to enable UEs to request particular SI/SIB(s), e.g., as described in more detail in connection with FIGS. 9 and 12-16.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

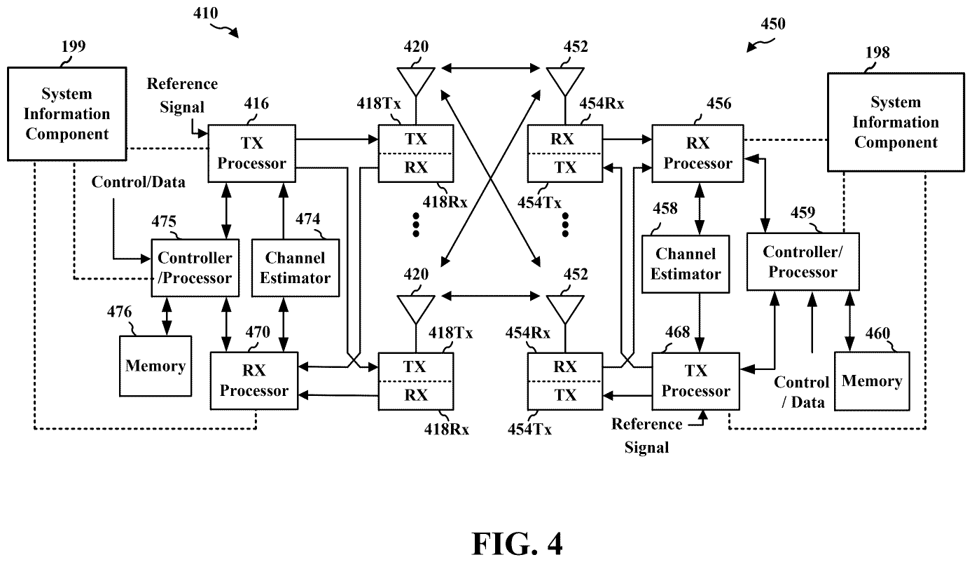

FIG. 4 is a block diagram that illustrates an example of a first wireless device that is configured to exchange wireless communication with a second wireless device. In the illustrated example of FIG. 4, the first wireless device may include a network node, which may be referred to as a radio node, DU, eDU, or base station 410. The second wireless device may include a UE 450, and the base station 410 may be in communication with the UE 450 in an access network. As shown in FIG. 4, the base station 410 may include a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the system information component 198 of FIG. 1.

At least one of the TX processor 416, the RX processor 470, and the controller/processor 475 may be configured to perform aspects in connection with the system information component 199 of FIG. 1.

Some wireless communication systems may include a service-based architecture, and may include a system information service (which may be referred to as an SI service) for a system information operation. Aspects presented herein provide a system information (SI) acquisition procedure for a service based architecture.

FIG. 5A is a diagram 500 illustrating an example function split between a core network 530 and a RAN 540. FIGS. 1 and 2 illustrate various example aspects of a core network (e.g., EPC 160, core network 190, 220), and FIG. 1 illustrates an example of a base station 102/180 as a RAN. FIG. 5A shows the UPF 595, SMF 594, and AMF 592 as part of the core network 530. FIG. 5A shows the CU-UP 502 (e.g., that provides user plane functionality), the CU-CP 504 (e.g., that provides control plane functionality), and the DU 506 provided as part of the RAN 540. The CU-CP and/or CU-UP may include aspects described for the CU 106 and/or 210 in FIG. 2. The DU 506 may include aspects described for the DU 105 in FIG. 1 or the DU 230 in FIG. 2. Aspects of the core network/RAN hierarchy in FIG. 5A may be employed, e.g., in 3G, 4G, and/or 5G wireless networks, as an example. The functional split in FIG. 5A may help to maintain performance and security of a wireless network and accessibility of on site equipment. FIG. 5A illustrates that some aspects of the core network 530 may include a cloud platform 508, and some aspects of the RAN 540 may include a cloud platform 510.

FIG. 5B is a diagram 525 illustrating example aspects of a cloud native platform (e.g., as shown at 526) for a wireless network that may include a merger (or combined functionality) of core network and RAN services. The platform may be referred to as a merged Core/RAN platform 550, for example. The combination of the functions between the core network and the RAN may simplify protocols and reduce duplication across the core network and RAN. FIG. 5B illustrates that services (which may include merged services that combine core network and RAN functionality) can be hosted in the wireless network based on a deployment topology and/or capabilities for each service's requirements. FIG. 5B illustrates multiple services 512, 514, and 516; multiple applications 520 and 522; and an enhanced distributed unit (eDU) 524 as part of the merged Core/RAN platform 550. The platform enables each service 512 to be updated independently of the other services. The services provide various functions for the wireless network. Examples of services may include access control services, mobility services, PWS services, V2X services, MBS services, and positioning services, among other examples. The platform may use an API interface 517, for example.

FIG. 6 is a diagram 600 showing a converged service based core network and RAN and shows that various functions performed by the core network (e.g., AMF 692) and the RAN (e.g., CU-CP 602 and/or the DU 604) can be distributed across the service based platform described in connection with FIG. 5B. FIG. 6 illustrates an example functional split 610 between the core network (e.g., 692) and the RAN (e.g., 602 and 604). As illustrated by the arrows, various aspects of the inter-DU functions 606 that are performed by the AMF 692 and/or the CU-CP 602 can be performed by different services 612 and 614 in the service based architecture. FIG. 6 illustrates that intra-DU functions 608 performed by the CU-CP 602 and/or the DU 604 can be performed by the eDU 624 (as an example of a network node or radio node) using the cloud based architecture 626. FIG. 6 also illustrates that the service based architecture may include one or more applications 620 and 622.

The converged service based core network and RAN may include a single cloud platform to host application(s), and the core network and RAN services, for example. The architecture can extend the benefits of a service based architecture to the RAN. The architecture may enable benefits relating to a cloud based system, e.g., including scalability, elasticity, resilience, reuse, agility, visibility, automation, and/or protection in case of failure, among other benefits. Each service (e.g., 512 or 612) can be scaled independently, and resources can be increased or decreased for individual services.

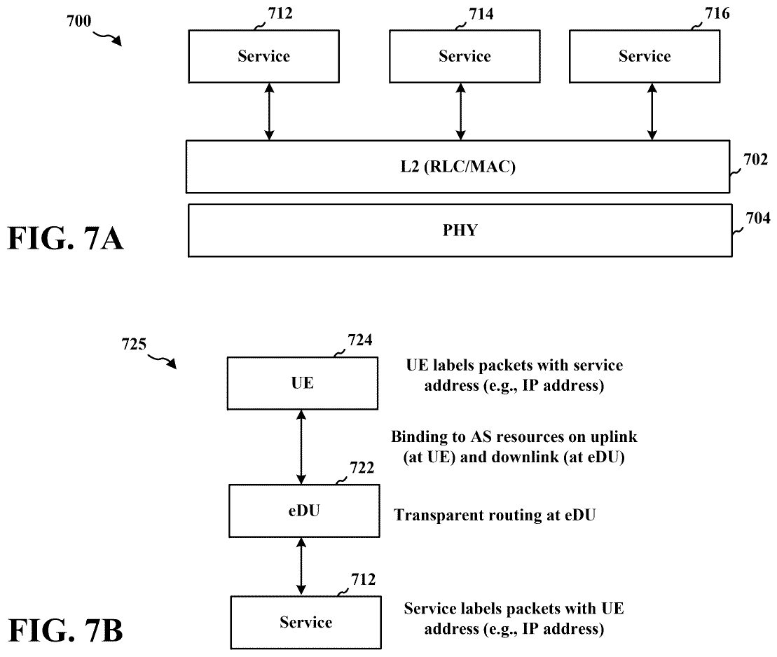

The functional split (e.g., as shown at 610) for the core network and RAN can be adjusted in order to leverage cloud deployments (e.g., in comparison to an appliance centered architecture). Such cloud platforms enable a redistribution of services or functions of the core network and RAN, and enables applications to share the common platform. The cloud based architecture enables real-time link management to the RAN edge. Adaptation at the DU, e.g., eDU or radio node, enables more efficient activation/deactivation/selection of features based on the intended user experience. The configuration aspects (e.g., RRC configuration) and activation/deactivation aspects (e.g., MAC layer aspects) for performance sensitive features can be decoupled from the service based architecture. FIG. 7A is a diagram 700 showing L2 functions 702 (e.g., RLC and/or MAC functions) and PHY layer aspects 704 separate from the services 712, 714, and 716, e.g., for a service based architecture such as in FIG. 5B or 6. Protocols may be specialized per service, and may be individually updated. The architecture enables adaptation across different verticals and deployment types. Different providers or hosts may provide different services.

FIG. 7B is a diagram 725 that illustrates an example of addressing and routing for packet transport between a service 712 and a UE 724 via the RAN, e.g., including the eDU 722. Although the eDU is illustrated as an example of a radio node, the radio node may also be referred to by other names, such as a network node, a network entity, or a network equipment, among other examples. The aspects may be applied for a service based architecture that includes aspects described in connection with FIG. 5B, 6, or 7A, for example. FIG. 7B illustrates an example of direct communication between the UE and a service of the wireless network. The UE 724 discovers the service routing information, e.g., which may include a uniform resource identifier (URI), or a port, among other examples. The UE labels packets to the service with the service address, which may include or be based on an IP address. The packets are provided to the service via an end-to-end routing layer from the UE 724 to the network service 712, e.g., with binding to access stratum (AS) resources on the uplink (e.g., at the UE) and downlink (e.g., at the eDU). The addressing of the packets enables transparent routing at the eDU 722, e.g., the service protocol layer may be transparent to the eDU 722. Similarly, when sending packets to the UE 724, the service 712 labels the packets with the UE address (e.g., an IP address for the UE).

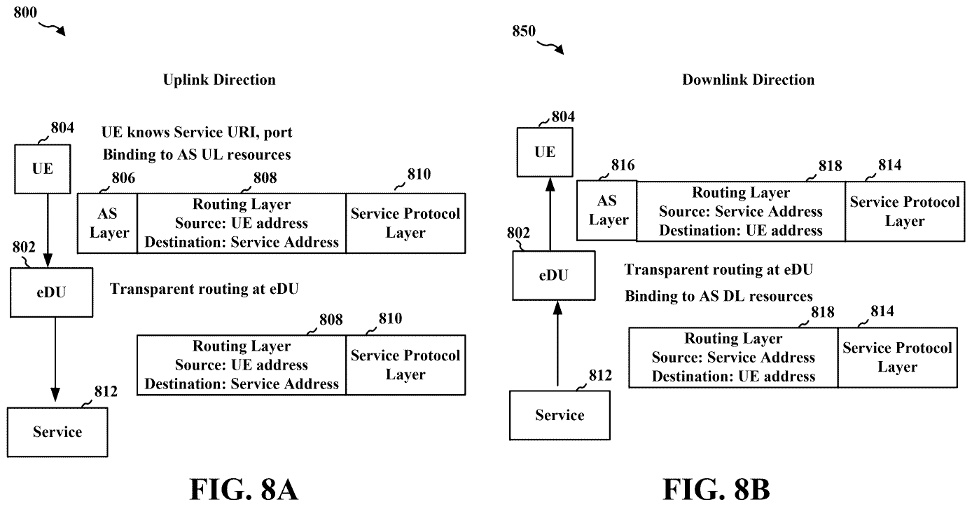

FIGS. 8A and 8B illustrate diagrams 800 and 850 showing additional example aspects of uplink and downlink packet handling for direct communication between a UE 804 and a service 812 via an eDU 802. Although the eDU is illustrated as an example of a radio node, the radio node may also be referred to by other names, such as a network node, a network entity, or a network equipment, among other examples. The aspects may be applied for a service based architecture that includes aspects described in connection with FIG. 5B, 6, 7A, or 7B, for example. FIG. 8A illustrates example aspects of uplink packet handling. The UE 804 knows the service URI and/or port for the service 812, and binds the packet to uplink resources (e.g., access stratum (AS) resources or a radio bearer), as described in connection with FIG. 7B. FIG. 8A illustrates an AS layer 806 and a service protocol layer 810, and additional illustrates a routing layer 808, where the packet is associated with the UE address as the source, and the service address as the destination. The routing at the eDU is transparent, e.g., based on the source and destination address of the routing layer.

FIG. 8B illustrates a corresponding example of downlink packet handling. The service 812 sends the packet to the UE 804, and the routing layer 818 is based on the service address as the source and the UE address as the destination. The routing is transparent at the eDU 802, e.g., using the routing layer information rather than the service protocol layer 814. The eDU binds the packet to AS downlink resources, e.g., a radio bearer, so that there is an AS layer 816, a routing layer 818, and a service protocol layer 814 for the downlink packet.

FIG. 9 illustrates example aspects of an architecture for system information (SI) generation and delivery 900 in a service based wireless network. The aspects may be applied for a service based architecture that includes aspects described in connection with FIG. 5B, 6, 7A, 7B, 8A, or 8B, for example. An SI service 908 may store and deliver service specific SI and/or SIBs for one or more services of the wireless network. The SI service 908 may support APIs for service specific SIB configuration by various services. FIG. 9 illustrates an example of a single service, e.g., service X. However, the network may include any number of services, and the aspects described for the service 912 may be applied for any of one or more services that provide system information to the SI service 912. Examples of services may include access control services, mobility services, PWS services, V2X services, MBS services, and positioning services, among other examples. The service 912 provides SI that is specific to that service (e.g., service X) to the SI service 908, e.g., via an API interface of a cloud platform 910 including the service 912 and the SI service 908. For example, the SI may include service specific SIB configurations for the service X. The SI service 908 may store the received SI from the service 912, and may generate and provide SI messages to the UE 902 that include the SI from the service 912. In some aspects, the SI service 908 may manage a delivery mode for the SI to the UE. The delivery mode may be broadcast, on-demand delivery, and/or download (e.g., on a UP) for example. In some aspects, the SI service 908 may provide delivery information (which may be referred to as delivery requirements in some examples) to the eDU 906. Although the eDU is illustrated as an example of a radio node, the radio node may also be referred to by other names, such as a network node, a network entity, or a network equipment, among other examples. The SI delivery information 907 may be referred to as SI for the SI service, for example. The SI service may handle SI updates, e.g., based on updated information received from various services, e.g., 712, and/or based on adjustments to the delivery of the SI.

The eDU 906 generates information related to the radio interface, e.g., MIB and/or minimum SI, among other examples. The eDU 906 supports APIs for a service SI radio configuration (e.g., the SI delivery information 907). The eDU 906 then provides a minimum SI delivery 909 over an access stratum 904. The minimum SI delivery may provide information that enables a UE to obtain other SI, e.g., rather than providing all of the SI. For example, the eDU 906 may transmit minimum SI for reception by one or more UEs 902. The eDU may also provide the service specific SI delivery (e.g., in a broadcast or on-demand transmission) as it receives SI from the SI service 908 to deliver to the one or more UEs 902 over the access stratum 904.

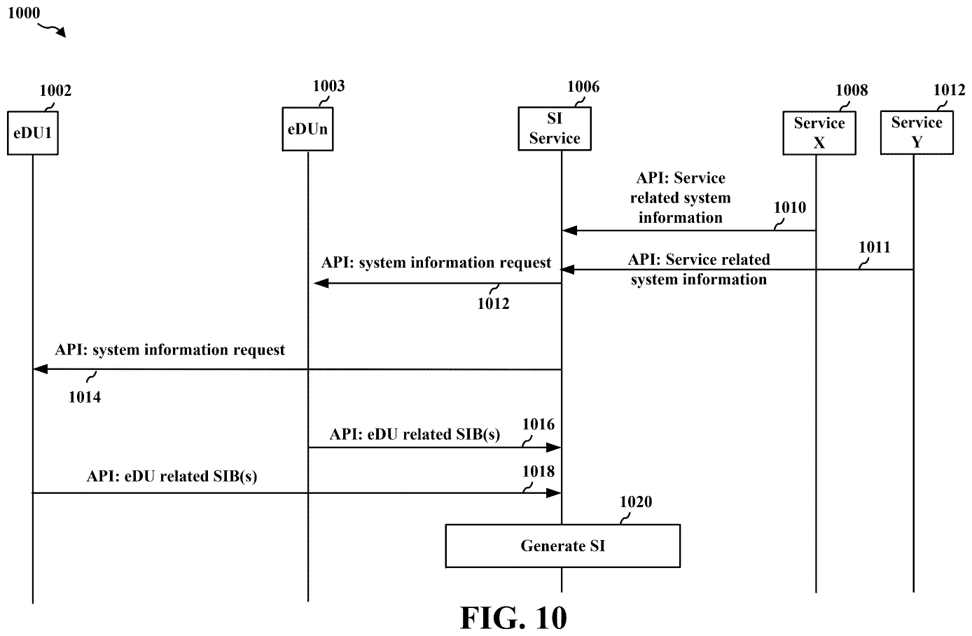

FIG. 10 illustrates an example communication flow 1000 in which an SI service 1006 collects, stores, and generates SI/SIBs. FIG. 10 illustrates that the SI service 1006 may receive service related SI 1010 and 1011 from one or more services (e.g., 1008 and 1012). For example, the SI 1010 may include SI that relates to the service 1008, and the SI 1011 may include SI that relates to the service 1012. The SI service 1112 may receive the SI 1010 and 1011 from the services 1008 and 1012 via an API interface as part of a cloud based platform, e.g., as described in connection with any of FIG. 5B, 6, 7A, 7B, 8A, 8B, or 9. In some aspects, one or more of the SI 1010 or 1011 may include an SI update of previously provided SI. In addition, the SI service 1006 may send a request (e.g., via the API interface) to an eDU to request SI. Although the eDU is illustrated as an example of a radio node, the radio node may also be referred to by other names, such as a network node, a network entity, or a network equipment, among other examples. As illustrated, the SI service 1006 may send such requests (e.g., 1012 and 1014) to one or more eDUs, e.g., 1002 and 1003. Each eDU 1002 and 1003 responds by providing the SI service 1006 with SI or SIBs that relate to the corresponding eDU. For example, the eDU 1002 provides to the SI service 1006 one or more SIB 1018 that relates to the eDU 1002. The eDU 1003 provides to the SI service 1006 one or more SIB 1016 that relates to the eDU 1003. The SI service collects, stores, and manages the SI received from various sources (e.g., including one or more service and one or more eDU). FIG. 10 illustrates that the SI service generates SI, at 1020, based on the SI received from the services and/or eDUs.

Aspects presented herein provide solutions for providing the SI from a SI service to one or more UEs, e.g., via an eDU or a core network service such as an ACMS. The examples provide delivery mechanisms for UEs having different eDU states (e.g., connected, authenticated, or not connected). The aspects presented herein enable a more efficient use of wireless resources by enabling the targeted delivery of SI/SIB(s) at the request of a UE. The aspects allow for SI for different services to be updated independently. The aspects enable greater network control over SI/SIBs by authenticating or authorizing a UE to access the information before the SI/SIBs are provided for the UE. The aspects may help to save power at the UE by reducing the time that the UE monitors for system information.

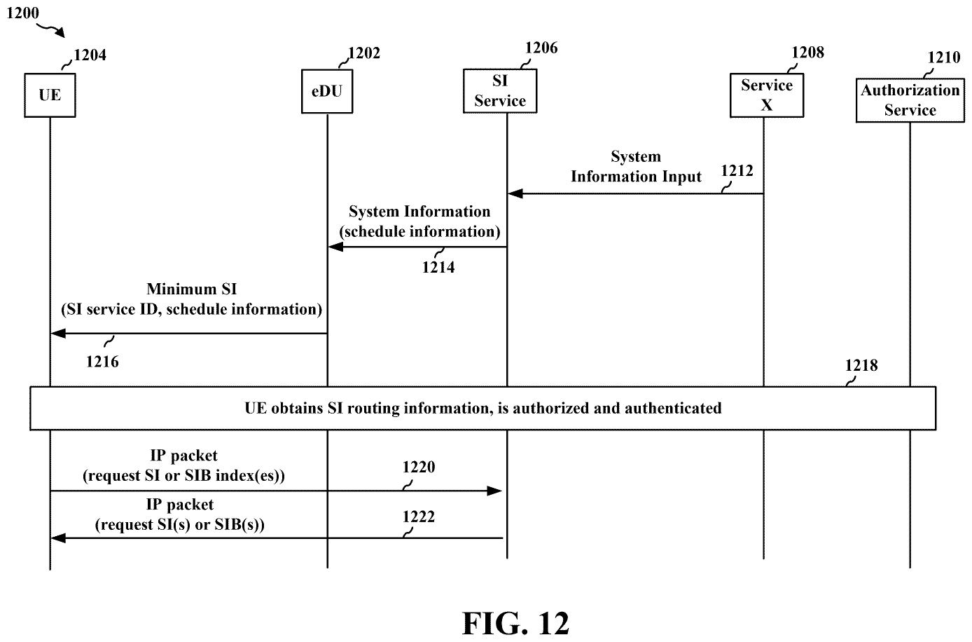

As an example, a UE may connect to an SI service over a UP to download the SI. In this example, the UE may be in a connected and authenticated state with the eDU (e.g., which may be referred to as an eDU state), and the UE may be established and authorized with the SI service. In some aspects, this method of receiving SI may be referred to as a connection based SI download. In this example, the UE may exchange communication with the SI service to its access to other services in the wireless network. FIG. 12 illustrates an example of a UE downloading SI over a UP.

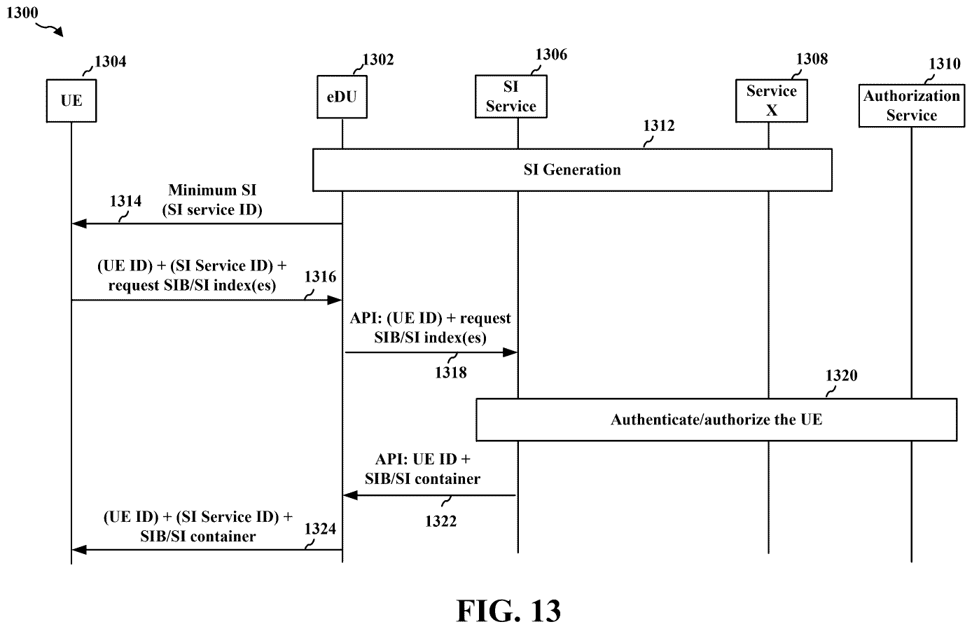

As another example, the UE may connect to an eDU, which may act as a proxy for the UE to retrieve SI from the SI service for the UE. In this example, the UE may be in a connected state or not in a connected state (e.g., with or without authentication) with the eDU. In this example, the SI service may be visible to the eDU rather than the UE, and the eDU may query the SI service for different UEs. In this example, the SI service functions as a service for the eDU, which may simplify the manner in which the SI is retrieved for the UE. For example, the eDU may register for the SI service and may cache SI or may retrieve the SI each time it is requested by a UE. FIG. 13 illustrates an example of an eDU obtaining SI for a UE.

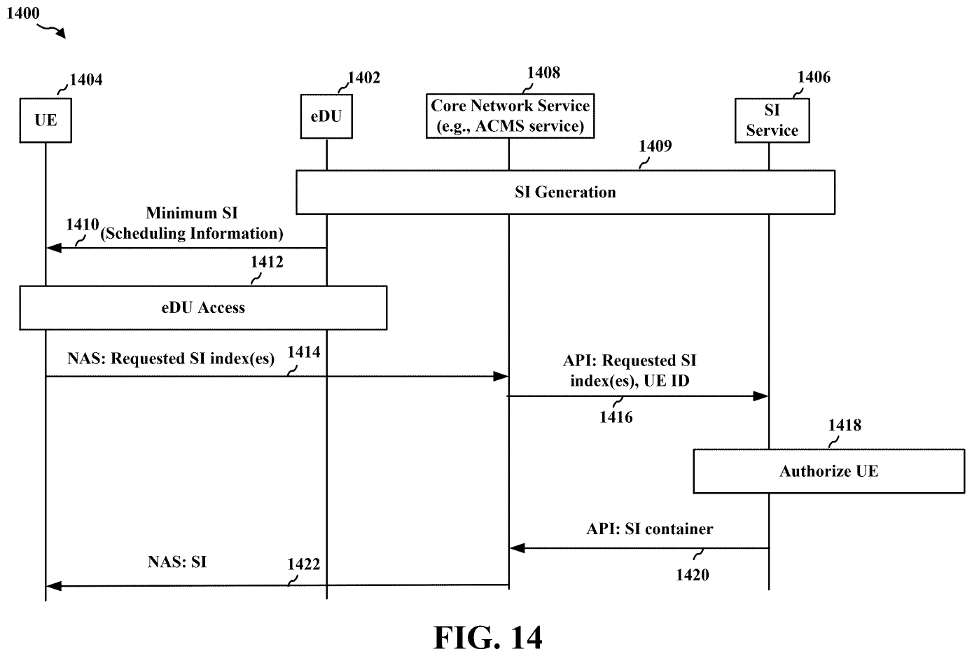

As another example, a network node, such as an access connection management service (ACMS), may query the SI service to obtain the SI for the UE. In this example, the UE may have a connected state with an eDU (e.g., with or without authentication). The SI service is visible to the ACMS rather than the UE, which enables the ACMS to request SI for different UEs. In this example, the SI service functions as a service for the ACMS, which may simplify the manner in which the SI is retrieved for the UE. FIG. 14 illustrates an example of an ACMS obtaining SI for a UE.

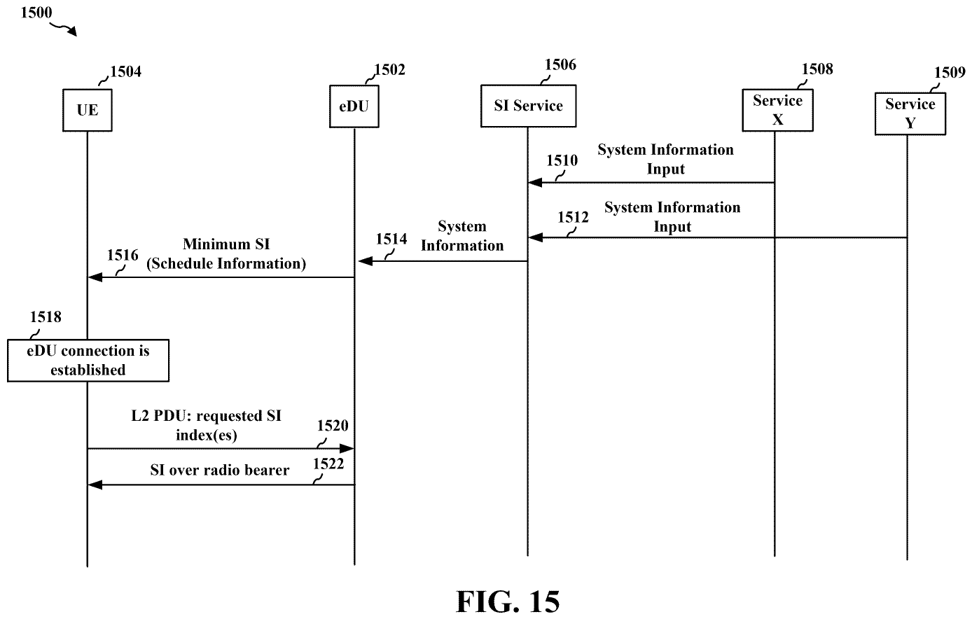

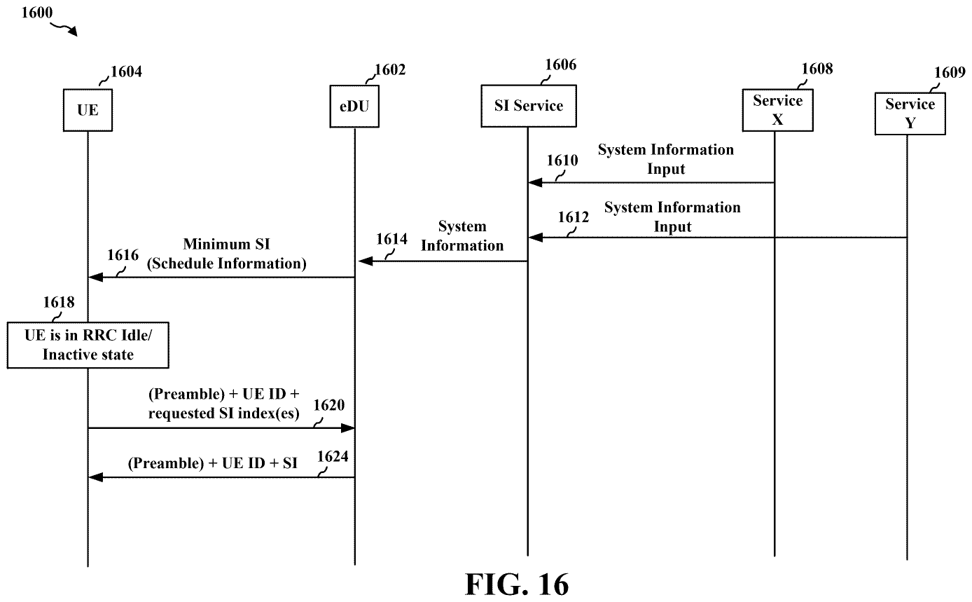

As another example, the UE may query for SI from the eDU. In this example, the UE may be in a connected state or not in a connected state with the eDU. The UE may not have a connection with the SI service or authorization with the SI service. The SI service may provide the requested SI to an eDU in advance of the UE's request. As an example, the SI may be provided to the eDU based on a subscription to the SI service (e.g., eDU subscription information). FIGS. 15 and 16 illustrate examples of an eDU receiving SI from an SI service prior to a UE request for the SI.

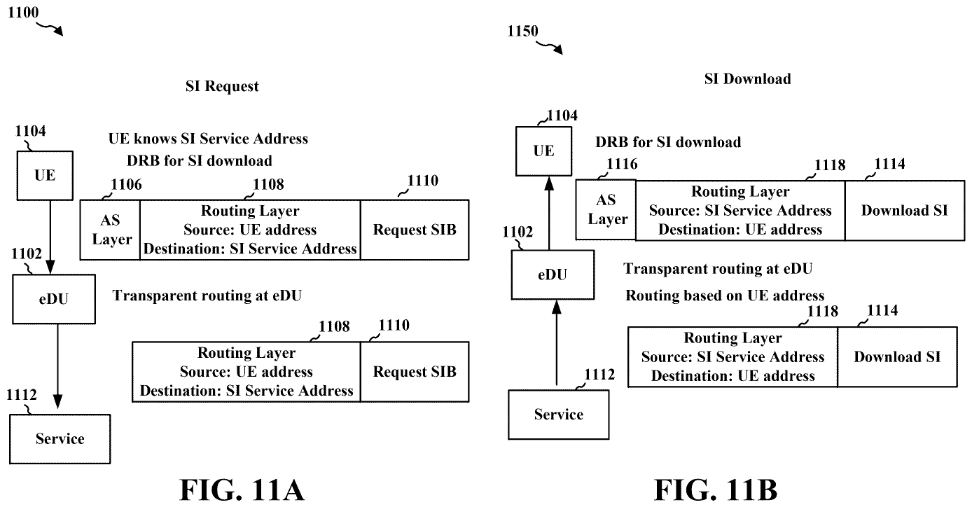

FIGS. 11A and 11B illustrate examples of uplink and downlink handling of an SI request and SI delivery for a connection based SI download of SI from an SI service. FIG. 11A is a diagram 1100 showing handling for an SI request for a connection based SI download from an SI service, e.g., over a user plane. The service 1112 may be a service of a cloud based wireless network such as described in connection with any of FIGS. 5B, 6, 7A, 7B, 9, and 10. The handling may include any of the aspects described in connection with the uplink handling in FIG. 8A, for example. The UE 1104 knows the SI service address, and uses a data radio bearer (DRB) for SI download. For example, the UE may be assigned an IP address (e.g., the UE address) and may be informed of routing information for the SI service 1112. The routing information for the SI service 1112 may include an IP address, a transmission control protocol (TCP) or user datagram protocol (UDP) port number, and/or a fully qualified domain name (FQDN) for the SI service. As the UE has already established an access connection with the eDU, the UE can use a configured radio bearer (e.g., a DRB for the SI download) to send the request for the SI. Although the eDU is illustrated as an example of a radio node, the radio node may also be referred to by other names, such as a network node, a network entity, or a network equipment, among other examples. The request from the UE is provided in a IP packet from the UE to the SI service 1112. FIG. 11A illustrates an AS layer 1106 and a service protocol layer 1110 (for the request of SI or SIB), and a routing layer 1108 for routing at the eDU with the UE address as the source, and the SI service address as the destination. For example, the UE may encapsulate the request for one or more SI and/or one or more SIBs (e.g., with one or more SI indexes or SIB indexes) into an UP packet, setting the destination address based on the SI service routing information and the source address to its own IP address. The routing at the eDU 1102 is transparent, e.g., based on the routing layer using the UE address as the source and the SI service address as the destination.

FIG. 11B illustrates example 1150 aspects of SI download for delivery the SI to the UE as downlink information. The service 1112 may be a service of a cloud based wireless network such as described in connection with any of FIGS. 5B, 6, 7A, 7B, 9, and 10. The handling may include any of the aspects described in connection with the downlink handling in FIG. 8B, for example. The SI service 1112 sends the SI to the UE 104 with a routing layer 1118 based on the SI service address as the source and the UE address as the destination. The routing is transparent at the eDU 1102, e.g., using the routing layer information rather than the service protocol layer 1114 for the download of the SI. Although the eDU is illustrated as an example of a radio node, the radio node may also be referred to by other names, such as a network node, a network entity, or a network equipment, among other examples. The eDU 1102 provides the SI to the UE 1104 over an access stratum (e.g., with AS layer 1116) using a DRB for SI download. The SI service 1112 may encapsulate the one or more requested SI or SIB (e.g., based on the one or more SI indexes or SIB indexes indicated by the UE) in one or more IP packets to the UE 1104. The downloaded SI(s) or SIB(s) are then routed between the UE 1104 and the SI service 1112 via the eDU 1102.

FIG. 12 illustrates an example communication flow 1200 for a connection based SI download from an SI service. The packet handling may include any of the aspects described in connection with FIG. 11A and/or 11B. The eDU 1202, the SI service 1206, the service 1208, and the authorization service 1210 may be part of a service based architecture in a cloud based wireless network, and may include aspects described in connection with any of FIGS. 5B, 6, 7A, 7B, 8A, 8B, 9, 10, and 11. Although the eDU is illustrated as an example of a radio node, the radio node may also be referred to by other names, such as a network node, a network entity, or a network equipment, among other examples.

At 1212, the service 1208 provides SI input 1212 to the SI service. Although a single service is illustrated, the SI service 1206 may receive SI input from any number of services in the wireless network. Each service, e.g., as represented by 1208) provides SI corresponding to the particular service. For example, FIG. 10 illustrates multiple services providing service specific SI to the SI service. Examples of services (e.g., 1208) may include access control services, mobility services, PWS services, V2X services, MBS services, and/or positioning services, among other examples. As an example, the service 1208 may correspond to a service that is requesting SI delivery by the SI service. By providing the SI to the SI service, the SI service 1206 can then manage the individual delivery to UEs. The SI input 1212 may include, for example, any of SI content for the service, an area of scope for the service, a periodicity, a value tag, a need for authorization to access the service, and/or aspects relating to authentication to access the service. The SI input 1212 may be provided by the service 1208 to the SI service 1206 via an API interface, for example.

At 1214, the SI service 1206 sends schedule information 1214 to the eDU 1202. The schedule information may refer to a reduced amount of system information to enable the UE to access the SI service in order to obtain other SI. For example, the schedule information 1214 may indicate an area of scope for the SI service 1206 and/or a delivery mode for obtaining SI from the SI service 1206. For example, the schedule information may indicate that the delivery mode to obtain the SI is via download from the SI Service and may indicate a service ID (e.g., an SI service ID).

As shown at 1216, the eDU 1202 may provide (e.g., transmit) a reduced amount of SI (which may be referred to as minimum SI 1216 or by other names), which may include the SI service ID (e.g., that the eDU 1202 received from the SI service 1206) and schedule information for the SI service 1206. For example, the minimum SI 1216 may indicate a delivery mode for SI, e.g., broadcast, on-demand, and/or download. In some aspects, the indication of the delivery mode may be per SIB or per SI. For example, the minimum SI 1216 may indicate different delivery modes for different SI or different SIBs. The minimum SI 1216 may include the schedule information 1214 provided by the SI service 1206, for example. In some aspects, the eDU 1202 may transmit the schedule information in a SIB1.

If the UE 1204 does not yet have SI routing information for the SI service 1206, the UE may obtain the SI routing information. The UE may obtain the SI routing information in any of multiple ways. The UE 1204 may also be authorized and authenticated, as shown at 1218 by an authorization service 1210 as part of obtaining the SI routing information.

In some aspects, as part of obtaining the SI routing information, the UE 1204 may establish a PDU Session and may be assigned an IP address (e.g., for the UE). The UE may also be provided the SI routing information for the SI service 1206. During the PDU session establishment, the UE 1204 can request the service ID (e.g., the SI service ID received in the minimum SI 1216) to be established.

In some aspects, the UE 1204 may obtain the SI routing information from a discovery service, for example. The UE may send a query message that includes the SI ID (received in the minimum SI) to the discovery service. The discovery service responds to UE's query message by sending the routing information for the SI service 1206 based on the SI ID indicated in the UE's query.

In some aspects, the UE 1204 may be preconfigured with the SI routing information, or may receive a configuration including the SI routing information from the network. As an example, the SI routing information may be provided to the UE by the network in a UE policy or a configuration. The network that provides the SI routing information may be a core network, such as a 6G core network, among other examples.

In some aspects, the UE 1204 may obtain the SI routing information from system information, e.g., in the minimum SI 1216.

In some aspects, the UE 1204 may construct (e.g., determine or generate) UE a FQDN according to some information received in the minimum SI 1216, such as a PLMN ID, a tracking area code (TAC), or an SI Service ID.

After obtaining the SI routing information, the UE 1204 sends (e.g., transmits) an IP packet 1220 that requests one or more SI or SIBs from the SI service 1206. The IP packet may include the aspects described in connection with FIG. 11A. The SI or SIBs may be for one or more particular services (e.g., including the service 1208). The eDU 1202 routes the IP packet to the SI service 1206, as described in connection with FIG. 11A. The SI service 1206 response to the request from the UE 1204 by sending one or more IP packet 1222 that includes the requested one or more SI or

SIBs. The IP packet 1222 may include aspects described in connection with the SI delivery in FIG. 11B, for example.

As presented in the examples shown in FIGS. 11A, 11B, and 12, the UE may request system information from the SI service using an IP packet, and the SI service may use one or more IP packets to encapsulate the SI or SIB payload when sending the SI to the UE. In connection with FIG. 12, mechanisms are also provided for enabling the UE to obtain an SI service address or other SI routing information. Aspects described in connection with FIG. 12 also enable the UE to be identified, authenticated, and/or authorized in order to access the SI.

By requesting and receiving the SI/SIB(s) in IP packets, the exchange can be made without a control plane between the UE 1204 and the SI service 1206. For example, the UE 1204 may have an eDU access connection without a control plane between the UE and the SI service. The aspects presented in connection with FIG. 12 allow for improved security and added network control of access to SI by enabling authentication and authorization for requested SI or SIBs. The aspects presented in FIG. 12 save radio resources and enable added system efficiency with reduced system overhead. For example, the SI can be provided in response to a UE request rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts.

In the example in FIG. 12, the UE1204 may already have an access connection with the eDU 1202, in some examples. In some aspects, the SI service 1206 may send the UE 1204 SIBs that are specific for that UE, e.g., such as V2X SIB(s), MBS SIB(s), among other examples.

FIG. 13 illustrates an example communication flow 1300 for an API based SI retrieval process in which the UE 1304 receives the SI from the eDU 1302. Although the eDU is illustrated as an example of a radio node, the radio node may also be referred to by other names, such as a network node, a network entity, or a network equipment, among other examples. The eDU 1302, the SI service 1306, and the authorization service 1310 may be part of a service based architecture in a cloud based wireless network, and may include aspects described in connection with any of FIG. 5B, 6, 7A, 7B, 8A, 8B, 9, or 10. For example, the UE 1304 may connect to the eDU 1302, which then acts as a proxy for the UE 1304 to retrieve SI from the SI service 1306 for the UE 1304. In this example, the UE 1304 may be in a connected state or not in a connected state (e.g., with or without authentication) with the eDU. In this example, the SI service may be visible to the eDU 1302 rather than the UE 1304. Although only a single UE 1304 and a single service 1308 are illustrated, the concepts presented in FIG. 13 may be applied for any number of UEs served by the eDU 1202 and any number of services 1208 in the wireless network. For example, the eDU 1202 may query the SI service 1206 for different UEs. In this example, the SI service 1206 may be considered to function as a service for the eDU 1202 (e.g., rather than for the UE 1204), which may simplify the manner in which the SI is retrieved for the UE 1204. For example, the eDU may register for the SI service and may cache SI or may retrieve the SI each time it is requested by a UE.

At 1312, SI may be obtained by the SI service 1206 and prepared for delivery to UEs. For example, the SI generation at 1312 may include any of the aspects described in connection with FIG. 9, FIG. 10, or the SI input 1212 in FIG. 12.

The UE 1304 may receive SIB or SI schedule information in minimum SI 1314. In some aspects, the scheduling information may indicate whether one or more SI or SIBs can be downloaded from the SI service 1306. The SI service 1306 may be identified by an SI service ID, for example. In some aspects, the eDU 1302 may have a subscription with the SI service 1306.

At 1316, the UE 1304 sends (e.g., transmits) a request 1316 for SI to the eDU 1302. The request may include the UE ID, in some aspects, e.g., for a UE in an RRC idle state. The request 1316 may request one or more SI or SIBs, and may include one or more indexes (e.g., SI index(es) or SIB index(es)) for the requested SI/SIBs. In some aspects, the request 1316 may include an SI Service ID identifying the SI service 1306 from which the UE is requesting the system information.

In some aspects, if the UE 1304 is in an RRC idle or RRC inactive state, the UE 1304 may use configured uplink resources (e.g., one or more of a configured frequency resource, time resource, and/or preamble resource) indicated in the minimum SI 1314 to send the request 1316. As an example, the request 1316 may be included in a random access message, such as a MSG 1.

In response to receiving the request from the UE 1304, the eDU 1302 retrieves the requested SIB/SI(s) from the SI service 1306. As an example, the eDU 1302 may obtain or receive the system information (e.g., the one or more requested SI or SIBs) from the SI service 1306 via an API interface. FIG. 13 illustrates that the eDU 1302 may send a request 1318 (e.g. via the API) that requests a set of one or more SI or SIBs for the UE. The request 1318 from the eDU 1302 may include an indication of the one or more SI or SIB indexes indicated in the request 1316 from the UE. In some aspects, the request 1318 may indicate the UE for which the request is being made, e.g., a UE ID.

In some aspects, the SI service 1306 may trigger a UE authorization and/or authentication procedure with an authorization and authentication service, e.g., 1310, before responding to the eDU's request.

As illustrated at 1322, the SI service 1306 may respond to the request 1318 from the eDU 1302 by sending the requested one or more SI or SIBs that were identified in the request 1318. The SI/SIBs may be provided to the eDU 1302 over an API interface, similar to the request 1318, for example. The eDU 1302 receives the requested one or more SI or SIBs and sends (e.g., transmits) an SI container to the UE, the SI container including the requested one or more SI or SIBs. The UE receives the SI/SIBs in a message 1324 from the eDU 1302. The message 1324 may indicate the UE ID in some aspects. The message 1324 may indicate the SI service ID for the SI service 1306 from which the system information was obtained, in some aspects. In the example in which the UE may send the request 1316 in a random access MSG1, the eDU 1302 may response to the UE's request by sending the requested system information (e.g., SI/SIBs) in a random access MSG2. The MSG2 may use a radio network temporary identifier (RNTI) for the UE, in some aspects.

The aspects presented in FIG. 13 save radio resources and enable added system efficiency with reduced system overhead. For example, the SI can be provided in response to a UE request, via an eDU, rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts. The aspects presented in connection with FIG. 13 also allow for improved security and added network control of access to SI by enabling authentication and authorization, at 1320, for requested SI or SIBs.

FIG. 14 illustrates an example communication flow 1400 for an API based SI retrieval from a core network service, such as an ACMS 1408. The eDU 1402, the SI service 1406, and the ACMS 1408 may be part of a service based architecture in a cloud based wireless network, and may include aspects described in connection with any of FIG. 5B, 6, 7A, 7B, 8A, 8B, 9, or 10. Although the eDU is illustrated as an example of a radio node, the radio node may also be referred to by other names, such as a network node, a network entity, or a network equipment, among other examples. The ACMS 1408 may query the SI service 1406 to obtain the SI for the UE 1404. In this example, the UE may have a connected state with an eDU 1402 (e.g., with or without authentication). The SI service 1406 is visible to the ACMS 1408 rather than the UE 1404. Although the concept is illustrated for a single UE 1404, the aspects of FIG. 14 enable the ACMS 1408 to request SI for different UEs. In this example, the SI service 1406 may be considered as functioning as a service for the ACMS 1408. This can simplify the manner in which the SI is retrieved for the UE 1404. In this example, the UE 1404 can request a SI download via control plane, e.g., via a NAS layer.

At 1409, SI may be obtained by the SI service 1306 and prepared for delivery to UEs. For example, the SI generation, at 1409, may include any of the aspects described in connection with FIG. 9, FIG. 10, or the SI input 1212 in FIG. 12.

The UE 1404 may receive SIB or SI schedule information in minimum SI 1410. In some aspects, the scheduling information may indicate whether one or more SI or SIBs can be downloaded from the SI service 1406 over a control plane (e.g., NAS layer). The minimum SI 1410 may include aspects such as described in connection with 1216 or 1314.

At 1414, the UE 1404 sends (e.g., transmits) a NAS message with a request 1416 for SI to the ACMS 1408. As illustrated at 1412, in some aspects, the UE 1404 may establish eDU access with the eDU 1402 prior to sending the request 1414. The request 1414 may include one or more indexes (e.g., SI index(es) or SIB index(es)) for the requested SI/SIBs. In response to receiving the request 1414, the ACMS 1408 sends the requested SI/SIB index(s) and a UE ID for the UE 1404 to the SI service 1406. For example, the ACMS 1408 may send the request 1416 for the SI/SIBs via an API interface. In some aspects, the UE ID may be e.g., a subscription permanent identifier (SUPI) or a generic public subscription identifier (GPSI).

The SI service 1406 responds to the request 1416 from the ACMS 1408 by sending the requested one or more SI or SIBs identified in the request 1416. For example, the SI service 1406 may send the SI/SIB(s) in a SIB or SI container 1420 via an API interface. The SI container 1420 may be included in a NAS message.

In some aspects, the SI service 1406 may perform an authorization procedure, at 1418, to determine whether the UE is authorized to download the requested system information prior to sending the SI container 1422 that includes the requested SI/SIBs.

The aspects presented in FIG. 14 save radio resources and enable added system efficiency with reduced system overhead. For example, the SI can be provided in response to a UE request, via an ACMS, rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts. The aspects presented in connection with FIG. 14 also allow for improved security and added network control of access to SI by enabling authorization, at 1418, for requested SI or SIBs.

FIG. 15 illustrates an example communication flow 1500 for SI/SIB acquisition from an eDU. Although the eDU is illustrated as an example of a radio node, the radio node may also be referred to by other names, such as a network node, a network entity, or a network equipment, among other examples. The acquisition may be based on a unicast delivery of the SI/SIB from the eDU. The eDU 1502, the SI service 1506, and the services 1508 and 1509 may be part of a service based architecture in a cloud based wireless network, and may include aspects described in connection with any of FIG. 5B, 6, 7A, 7B, 8A, 8B, 9, or 10. Although the concept is illustrated for a single UE 1504, the aspects of FIG. 15 may be applied for any number of UEs.

As shown at 1510 and 1512, SI may be obtained by the SI service 1506. For example, the SI service 1506 may generate SI such as described in connection with FIG. 9, FIG. 10, or the SI input 1212 in FIG. 12. The eDU 1502 may provide minimum SI 1516 with schedule information about obtaining the SI from the SI service 1506, e.g., as described in connection with the minimum SI in any of FIGS. 12-14.

In the example in FIG. 15, the UE 1504 may query for SI from the eDU 1502. In FIG. 15, the UE 1504 is in a connected state, and has established a connection with the eDU 1502 at 1518 prior to requesting the system information. The UE 1504 may not have a connection with the SI service 1506 or may not have an authorization with the SI service 1506. The SI service 1506 may provide the requested SI to an eDU 1502, at 1514, in advance of the UE's request 1520. As an example, the SI may be provided to the eDU 1502 based on a subscription to the SI service 1506 (e.g., eDU subscription information).

The UE 1504 transmits a request 1520 for one or more SI or SIBs to the eDU 1502, and the eDU 1502 responds to the request 1520 by sending (e.g., transmitting) the requested SIB/SI(s) to the UE 1504. In this example, the UE has an eDU access connection, e.g., a radio bearer established, and the UE can indicate the requested SIB/SI index(es) in L2 PDU, e.g. in MAC CE. Thus, the request 1520 may be a MAC-CE or L2 PDU that indicates one or more SI or SIB indexes that the UE 1504 is requesting. The eDU delivers the requested system information (e.g., SI/SIBs) over the established radio bearer, at 1522. In some aspects, the UE 1504 may use a default (e.g., a specified) radio bearer or a configured radio bearer for sending the request 1520 to request the system information.

The SI service 1506 may determine the SIB/SI(s) delivered by the eDU 1502, and may send the SIB/SI(s) to the eDU 1502, at 1514. The SI service 1506 may also send schedule information to the eDU 1502, e.g., at 1514 or in a separate message. The schedule information may indicate one or more SIBs or SI that UEs can acquire from the eDU 1502. The eDU 1502 may then provide similar information in the minimum SI 1516, e.g., indicating one or more SIBs or SI that a UE can request from the eDU 1502.

The aspects presented in FIG. 15 save radio resources and enable added system efficiency with reduced system overhead. For example, the SI can be provided in response to a UE request rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts. The aspects presented in connection with FIG. 15 also allow for quicker delivery of the system information, as it is already stored at the eDU 1502 when the request is received from the UE 1604.

FIG. 16 illustrates an example communication flow 1600 for SI/SIB acquisition from an eDU similar to FIG. 15, yet for a UE 1604 that does not have an established connection to the eDU 1602. Although the eDU is illustrated as an example of a radio node, the radio node may also be referred to by other names, such as a network node, a network entity, or a network equipment, among other examples. For example, as shown at 1618, the UE may be in an RRC idle or inactive state. The acquisition may be based on a unicast delivery of the SI/SIB from the eDU. The eDU 1602, the SI service 1606, and the services 1608 and 1609 may be part of a service based architecture in a cloud based wireless network, and may include aspects described in connection with any of FIG. 5B, 6, 7A, 7B, 8A, 8B, 9, or 10. Although the concept is illustrated for a single UE 1604, the aspects of FIG. 16 may be applied for any number of UEs.

As shown at 1610 and 1612, SI may be obtained by the SI service 1606. For example, the SI service 1506 may generate SI such as described in connection with FIG. 9, FIG. 10, or the SI input 1212 in FIG. 12. The eDU 1602 may provide minimum SI 1616 with schedule information about obtaining the SI from the SI service 1606, e.g., as described in connection with the minimum SI in any of FIGS. 12-14.

In the example in FIG. 16, the UE 1604 may query for SI from the eDU 1602. The UE 1604 does not have a connection with the SI service 1606 or may not have an authorization with the SI service 1506. The SI service 1606 may provide the requested SI to an eDU 1602, at 1614, in advance of the UE's request 1620. As an example, the SI may be provided to the eDU 1502 based on a subscription to the SI service 1606 (e.g., eDU subscription information).

The UE 1604 transmits a request 1614 for one or more SI or SIBs to the eDU 1602, and the eDU 1602 responds to the request 1620 by sending (e.g., transmitting) the requested SIB/SI(s) to the UE 1604.

In this example, the UE is in an idle or inactive state (e.g., an RRC idle or RRC inactive state without an established connection). The UE 1604 may send the request for the one or more SI or SIBs in a PDU (e.g., a SIB/SI request PDU) to the eDU 1602. The the PDU may be a L2 PDU, and may include a UE ID for the UE 1604 and indexes for one or more SI or SIBs that are requested by the UE 1604. In some aspects, the PDU may be included, e.g., in a MAC-CE message from the UE 1604. The eDU delivers the requested system information (e.g., SI/SIBs), at 1624. The eDU 1602 may include the requested SI or SIBs in a L2 PDU that the eDU 1602 sends to the UE 1604.

As an example, in an RRC idle or RRC inactive state, the UE 1604 may transmit the request along with a preamble, and the eDU 1602 may respond by sending the requested SI/SIBs and the preamble.

The aspects presented in FIG. 16 save radio resources and enable added system efficiency with reduced system overhead. For example, the SI can be provided in response to a UE request rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts. The aspects presented in connection with FIG. 16 also allow for quicker delivery of the system information, as it is already stored at the eDU 1602 when the request is received from the UE 1604.

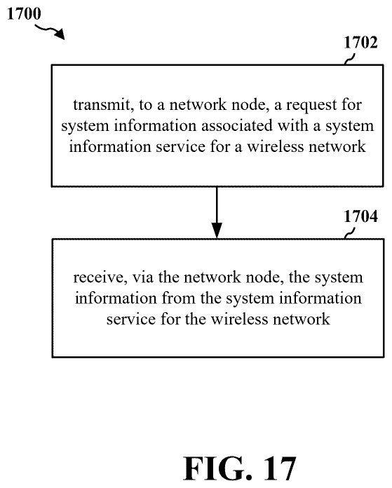

FIG. 17 is a flowchart 1700 of a method of wireless communication. The method may be performed by a UE (e.g., the UE 104, 204, 450, 724, 804, 902, 1104, 1204, 1304, 1404, 1504, 1604; the apparatus 2204). Aspects of the method allow for improved security and added network control of access to SI by enabling authentication and authorization for requested SI or SIBs. The aspects save radio resources and enable added system efficiency with reduced system overhead. For example, the SI can be provided in response to a UE request rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts.

At 1702, the UE transmits, to a network node, a request for system information associated with a system information service for a wireless network. FIGS. 12-16 illustrates various examples of a UE transmitting a request for system information associated with an SI service. For example, the transmission may be performed by the system information component 198, e.g., of the apparatus 2204. In some aspects, the request for the UE includes a first internet protocol (IP) packet including a source IP address of the UE and a destination IP address of the system information service, and wherein the system information is received in a second IP packet that encapsulates the system information. FIG. 12 illustrates an example in which the UE may encapsulate the request in an IP packet. In some aspects, the UE further establishes a protocol data unit (PDU) session prior to the request. In some aspects, the request for the UE is directed to one or more radio nodes and includes one or more of: a first identifier (ID) of the UE, a service ID of the system information service, or a system information index. FIGS. 13, 14, and 15 illustrate examples in which the UE directs a request to an eDU or ACMS.

In some aspects, the UE further receives, prior to transmitting the request, initial system information that indicates a service identifier for the system information service and a delivery mode for the system information. For example, the reception may be performed by the system information component 198, e.g., of the apparatus 2204. In some aspects, the initial system information indicates the delivery mode for the system information based on one or more of: broadcast, on-demand download, download over a user plane, download for each system information or system information block (SIB), download from the system information service, download via a radio node, or download via an access connection management service (ACMS).

In some aspects, the UE further obtains routing information for the system information service from one or more of: a discovery service, previously configured SI routing information, or minimum system information. In some aspects, the UE further generates a fully qualified domain name (FQDN) for the system information service based on one or more of a public land mobile network identifier (PLMN ID), a tracking area code (TAC), and a service identifier (ID) for the system information service. In some aspects, the UE further receives minimum system information from the one or more radio nodes indicating the service ID of the system information service.

At 1704, the UE receives, via the network node, the system information from the system information service for the wireless network. For example, the reception may be performed by the system information component 198, e.g., of the apparatus 2204. In some aspects, the system information is in a message or a system information container from a radio node. In some aspects, the request is in a first random access message, and the system information is included in a second random access message. In some aspects, the request for the UE is included in a first non-access stratum (NAS) message directed to an access connection management service (ACMS) and indicates a system information index, and wherein the system information is received in a second NAS message from the ACMS that encapsulates the system information indicated by the system information index. In some aspects, the request for the UE is included in a first protocol data unit (PDU) directed to a radio node, and wherein the system information is received in a second PDU from the radio node.

In some aspects, the UE has an access connection with the radio node, wherein the request is included in a layer 2 (L2) PDU to the radio node, and wherein the system information is included in a response L2 PDU from the radio node. FIG. 15 illustrates an example in which a UE having an access connection includes the request in an L2 PDU. In some aspects, the UE does not have an established connection with the radio node, and the request is included in a system information block (SIB) or system information (SI) request PDU to the radio node, and the system information is included in a layer 2 (L2) PDU from the radio node. FIG. 16 illustrates an example in which a UE without an access connection includes the request in an L2 PDU.

In some aspects, the UE further exchanges communication via the wireless network based on the system information associated with the system information service.

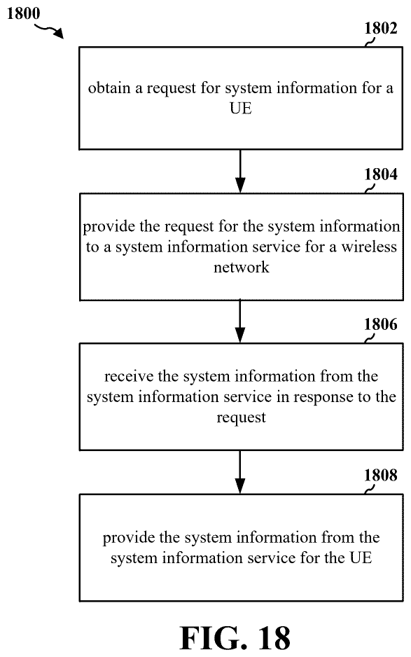

FIG. 18 is a flowchart 1800 of a method of wireless communication. The method may be performed by a network node, which may be a base station or a component of a base station (e.g., the base station 102, 202, 410; the CU 106, the DU 105, 230; the RU 109, 240; the eDU 171, 524, 624, 722, t802, 906, 1002, 1003, 1102, 1202, 1302, 1402, 1502; the ACMS 1408; the network entity 2302, 2560). Aspects of the method allow for improved security and added network control of access to SI by enabling authentication and authorization for requested SI or SIBs. The aspects save radio resources and enable added system efficiency with reduced system overhead. For example, the SI can be provided in response to a UE request rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts.

At 1802, the network node obtains a request for system information for a UE. FIGS. 12-16 illustrate various examples of a network node obtaining (e.g., receiving) a request for system information for a UE. The request may be obtained, e.g., by the system information component 199 of the network entity 2302, for example. In some aspects, the request for the UE includes a first IP packet including a source IP address of the UE and a destination IP address of the system information service, the system information is in a second IP packet that encapsulates the system information. In some aspects, the network node is a radio node, the request for the UE is directed to the radio node and includes one or more of: a UE ID of the UE, a service ID of the system information service, or a system information index. In some aspects, the network node includes an access connection management service (ACMS), and wherein the request for the UE is included in a first non-access stratum (NAS) message directed to the ACMS.

At 1804, the network node provides the request for the system information to a system information service for a wireless network. The request may be provided, e.g., by the system information component 199 of the network entity 2302, for example. In some aspects, providing the request to the system information service includes providing the first IP packet to the system information service. In some aspects, the network node is a radio node, the request for the UE is directed to the radio node and includes one or more of: a UE ID of the UE, a service ID of the system information service, or a system information index, and providing the request for the system information to the system information service includes sending an additional request to the system information service indicating one or more of the UE ID or the system information index.

At 1806, the network node receives the system information from the system information service in response to providing the request. The system information may be obtained, e.g., by the system information component 199 of the network entity 2302, for example. FIGS. 12, 13, and 14 illustrate various examples of a network node receiving system information from an SI service.

At 1808, the network node provides the system information from the system information service for the UE. The system information may be provided, e.g., by the system information component 199 of the network entity 2302, for example. In some aspects, the network node may transmit the system information from the SI service to the UE. FIGS. 12-16 illustrate various examples of a network node providing (e.g., transmitting) system information to a UE in response to a request. In some aspects, the system information is in a second IP packet that encapsulates the system information. In some aspects, the system information is in a message, a system information container, or a random access message from the radio node for the UE. In some aspects, the network node includes an access connection management service (ACMS), and wherein the request for the UE is included in a first non-access stratum (NAS) message directed to the ACMS and indicating a system information index, and the system information is provided in a second NAS message from the ACMS that encapsulates the system information indicated by the system information index.

In some aspects, the network node further provides, prior to the request, initial system information that indicates a service identifier for the system information service and a delivery mode for the system information. For example, FIGS. 12-16 illustrate examples in which a network node may provide minimum SI to the UE prior to a SI request from the UE.

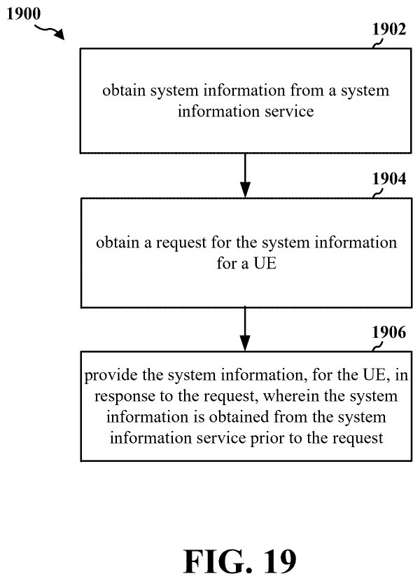

FIG. 19 is a flowchart 1900 of a method of wireless communication. The method may be performed by a network node, which may be a base station or a component of a base station (e.g., the base station 102, 202, 410; the CU 106, the DU 105, 230; the RU 109, 240; the eDU 171, 524, 624, 722, t802, 906, 1002, 1003, 1102, 1502; the network entity 2302, 2560). Aspects of the method allow for improved security and added network control of access to SI by enabling authentication and authorization for requested SI or SIBs. The aspects save radio resources and enable added system efficiency with reduced system overhead. For example, the SI can be provided in response to a UE request rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts.

At 1902, the network node obtains system information from a system information service. The system information may be obtained, e.g., by the system information component 199 of the network entity 2302, for example. FIG. 15 and FIG. 16 illustrate examples of a network node (e.g., eDU) obtaining system information from an SI service.

At 1904, the network node obtains a request for the system information for a UE. In some aspects, the network node may receive the request from the UE. The request may be obtained, e.g., by the system information component 199 of the network entity 2302, for example. FIG. 15 and FIG. 16 illustrate examples of a network node (e.g., eDU) receiving a request from a UE for system information (e.g., one or more SI or SIBs).

At 1906, the network node may provide the system information, for the UE, in response to the request, wherein the system information is obtained from the system information service prior to the request (e.g., previously obtained). In some aspects, the network node may transmit the system information to the UE in response to the request. The system information may be provided, e.g., by the system information component 199 of the network entity 2302, for example. FIG. 15 and FIG. 16 illustrate examples of a network node (e.g., eDU) providing system information (e.g., one or more SI or SIBs) in response to a UE request. As the eDU already has the system information, e.g., stores the system information, the eDU may provide the system information more quickly to the UE in response to the UE's request.

In some aspects, the techniques described herein relate to a method, the network node is a radio node, and wherein the request for the UE is included in a first protocol data unit (PDU) directed to the radio node, and the system information is in a second PDU from the radio node for the UE.

In some aspects, the techniques described herein relate to a method, wherein the radio node has a connection with the UE, and the request is included in a layer 2 (L2) PDU to the radio node, and the system information is included in a response L2 PDU from the radio node. FIG. 15 illustrates example aspects for a UE having a connection with an eDU.

In some aspects, the radio node does not have an established connection with the UE, and the request is included in a SIB or SI request PDU to the radio node, and the system information is included in a L2 PDU from the radio node. For example, the UE may be in an RRC idle or RRC inactive state. The UE may have not yet established a connection, e.g., the UE may request the SI/SIB(s) along with an initial access to a cell. FIG. 16 illustrates example aspects for a UE that does not have a connection with an eDU, e.g., that is in an RRC idle or RRC inactive state.

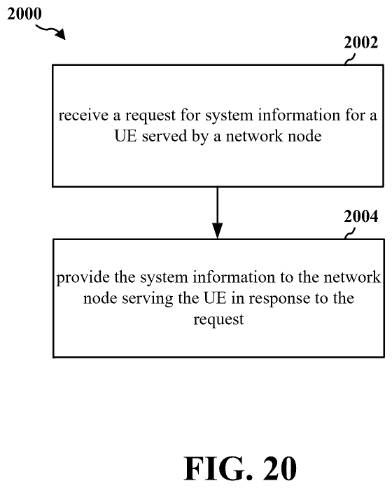

FIG. 20 is a flowchart 2000 of a method of wireless communication. The method may be performed by a system information service in a service based wireless network (e.g., the SI service 173, 908, 1006, 1112, 1206, 1306, 1406, 1506, 1606; service 512, 612, 712, 812; the network entity 2560). Aspects of the method allow for improved security and added network control of access to SI by enabling authentication and authorization for requested SI or SIBs. The aspects save radio resources and enable added system efficiency with reduced system overhead. For example, the SI can be provided in response to a UE request rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts.

At 2002, the system information service receives a request for system information for a UE served by a network node. The reception may be performed, e.g., by the system information component 191 of the network entity 2560. In some aspects, the request is included in a first internet protocol (IP) packet for the UE and includes a source IP address of the UE and a destination IP address of the system information service. In some aspects, the network node is a serving radio node that is serving the UE, and the request is from the serving radio node and includes one or more of: a UE identifier (ID) of the UE, a service ID of the system information service, and a system information index. In some aspects, the network node includes an access connection management service (ACMS), wherein the request is from the ACMS and indicates a UE identifier. In some aspects, the UE identifier is a subscription permanent identifier (SUPI) or a generic public subscriber identifier (GPSI). For example, FIGS. 12, 13, and 14 illustrate examples of an SI service receiving a request for SI.

At 2004, the system information service provides the system information to the network node serving the UE in response to the request. The providing may be performed, e.g., by the system information component 191 of the network entity 2560. In some aspects, the system information is provided in a second IP packet to that encapsulates the system information from the system information service. For example, FIGS. 12, 13, and 14 illustrate examples of an SI service providing the SI to a network node.

In some aspects, the system information service further obtains the system information from one or more of a service of the wireless network or a radio node for the wireless network. The obtaining may be performed, e.g., by the system information component 191 of the network entity 2560.

In some aspects, the system information service further performs at least one of an authorization or authentication for the UE with an authorization service prior to providing the system information to the serving radio node in response to the request.

In some aspects, the system information service further performs at least one of an authorization or authentication for the UE with an authorization service prior to providing the system information to the ACMS in response to the request.

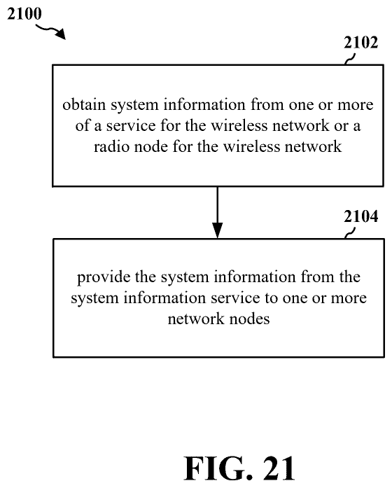

FIG. 21 is a flowchart 2100 of a method of wireless communication. The method may be performed by a system information service in a service based wireless network (e.g., the SI service 173, 908, 1006, 1112, 1206, 1306, 1406, 1506, 1606; service 512, 612, 712, 812; the network entity 2560). Aspects of the method allow for improved security and added network control of access to SI by enabling authentication and authorization for requested SI or SIBs. The aspects save radio resources and enable added system efficiency with reduced system overhead. For example, the SI can be provided in response to a UE request rather than reserving windows of resources for the period broadcast of SI. The more efficient delivery may enable an increase in a maximum number for SI or SIBs. The delivery in response to a UE request enables more granular control of SI, e.g., enabling SI for different services to be independently updated. Aspects presented herein can also reduce UE power consumption because the UE can request SI and may skip monitoring of periodic SI broadcasts.

At 2102, the system information service obtains system information from one or more of a service for the wireless network or a radio node for the wireless network. In some aspects, a radio node may be an eDU or a DU. As an example, the radio node may provide messages or signaling to one or more UEs. The obtaining may be performed, e.g., by the system information component 191 of the network entity 2560. FIGS. 15 and 16 illustrate examples of a SI service receiving system information from services(s) or radio node(s) (e.g., eDU(s)).

At 2104, the system information service provides the system information to one or more network nodes. The providing may be performed, e.g., by the system information component 191 of the network entity 2560. FIGS. 15 and 16 illustrate examples of a SI service providing system information to a service (e.g., ACMS) or radio node (e.g., eDU).

In some aspects, the system information service may further provide, to the radio node, schedule information for the system information to be acquired from the radio node.

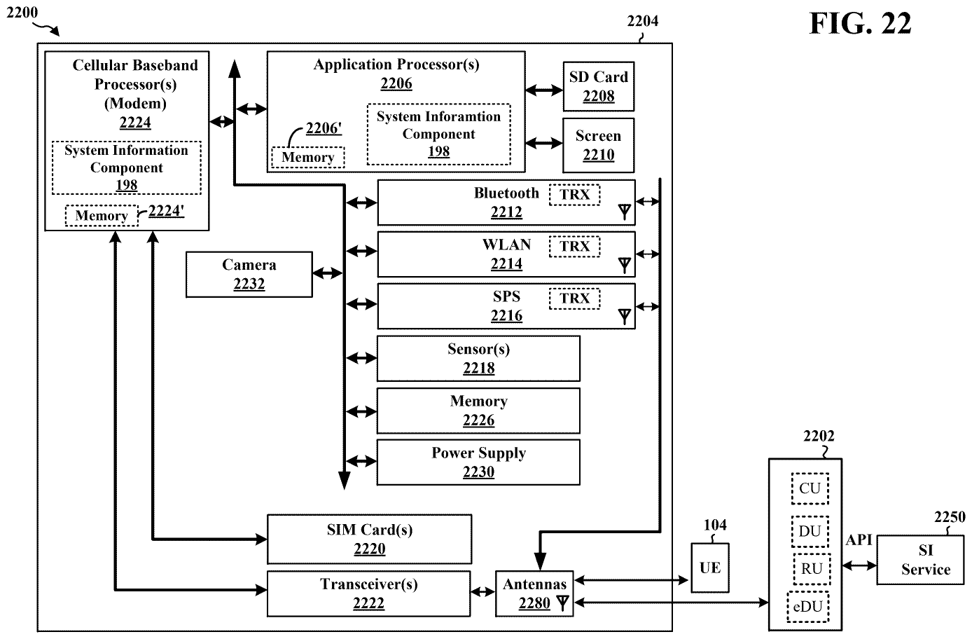

FIG. 22 is a diagram 2200 illustrating an example of a hardware implementation for an apparatus 2204. The apparatus 2204 may be a UE, a component of a UE, or may implement UE functionality. In some aspects, the apparatus 2204 may include at least one cellular baseband processor 2224 (also referred to as a modem or processor circuitry) coupled to one or more transceivers 2222 (e.g., cellular RF transceiver). The cellular baseband processor(s) 2224 may include at least one on-chip memory 2224′ (or memory circuitry). In some aspects, the apparatus 2204 may further include one or more subscriber identity modules (SIM) cards 2220 and at least one application processor 2206 (or processor circuitry) coupled to a secure digital (SD) card 2208 and a screen 2210. The application processor(s) 2206 may include on-chip memory 2206′ (or memory circuitry). In some aspects, the apparatus 2204 may further include a Bluetooth module 2212, a WLAN module 2214, an SPS module 2216 (e.g., GNSS module), one or more sensor modules 2218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules (e.g., 2226), a power supply 2230, and/or a camera 2232. The Bluetooth module 2212, the WLAN module 2214, and the SPS module 2216 may include an on-chip transceiver (TRX) (or in some cases, just a receiver (RX)). The Bluetooth module 2212, the WLAN module 2214, and the SPS module 2216 may include their own dedicated antennas and/or utilize the antennas 2280 for communication. The cellular baseband processor(s) 2224 communicates through the transceiver(s) 2222 via one or more antennas 2280 with the UE 104 and/or with a network entity 2202 (e.g., such as with an RU or eDU associated with the network entity 2202), e.g., to obtain SI from an SI service 2250. The cellular baseband processor(s) 2224 and the application processor(s) 2206 may each include a computer-readable medium/memory 2224′, 2206′, respectively. The additional memory modules (e.g., 2226) may also be considered a computer-readable medium/memory. Each computer-readable medium/memory 2224′, 2206′, 2226 may be non-transitory. The cellular baseband processor(s) 2224 and the application processor(s) 2206 are each responsible for general processing, including the execution of software stored on the computer-readable medium/memory. The software, when executed by the cellular baseband processor(s) 2224/application processor(s) 2206, causes the cellular baseband processor(s) 2224/application processor(s) 2206 to perform the various functions described supra. The cellular baseband processor(s) 2224 and the application processor(s) 2206 are configured to perform the various functions described supra based at least in part of the information stored in the memory. That is, the cellular baseband processor(s) 2224 and the application processor(s) 2206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2224/application processor(s) 2206 when executing software. The cellular baseband processor(s) 2224/application processor(s) 2206 may be a component of the UE 450 and may include the at least one memory 460 and/or at least one of the TX processor 468, the RX processor 456, and the controller/processor 459. In one configuration, the apparatus 2204 may be at least one processor chip (modem and/or application) and include just the cellular baseband processor(s) 2224 and/or the application processor(s) 2206, and in another configuration, the apparatus 2204 may be the entire UE (e.g., see UE 450 of FIG. 4) and include the additional modules of the apparatus 2204.

As discussed supra, the component 198 may be configured to transmit, to a network node, a request for system information associated with a system information service for a wireless network; and receive, via the network node, the system information from the system information service for the wireless network. In some aspects, the system information component 198 is further configured to receive, prior to transmission of the request, initial system information that indicates a service identifier for the system information service and a delivery mode for the system information. In some aspects, the system information component 198 is further configured to establish a PDU session prior to the request. In some aspects, the system information component 198 is further configured to obtain routing information for the system information service from one or more of: a discovery service, previously configured SI routing information, or minimum system information. In some aspects, the system information component 198 is further configured to generate an FQDN for the system information service based on one or more of a PLMN ID, a TAC, and a service ID for the system information service. In some aspects, the system information component 198 is further configured to receive minimum system information from the one or more radio nodes that indicates the service ID of the system information service. In some aspects, the system information component 198 is further configured to exchange communication via the wireless network based on the system information associated with the system information service. The component 198 may be further configured to perform any of the aspects described in connection with the flowchart in FIG. 17 or performed by the UE in any of FIGS. 12-16. The component 198 may be within the cellular baseband processor(s) 2224, the application processor(s) 2206, or both the cellular baseband processor(s) 2224 and the application processor(s) 2206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2204 may include a variety of components configured for various functions. In one configuration, the apparatus 2204, and in particular the cellular baseband processor(s) 2224 and/or the application processor(s) 2206, may include means for transmitting, to a network node, a request for system information associated with a system information service for a wireless network; and means for receiving, via the network node, the system information from the system information service for the wireless network. The apparatus 2204 may further include means for receiving, prior to transmitting the request, initial system information that indicates a service identifier for the system information service and a delivery mode for the system information. The apparatus 2204 may further include means for establishing a protocol data unit (PDU) session prior to the request. The apparatus 2204 may further include means for obtaining routing information for the system information service from one or more of: a discovery service, previously configured SI routing information, or minimum system information. The apparatus 2204 may further include means for generating an FQDN for the system information service based on one or more of a PLMN ID, a TAC, and a service ID for the system information service. The apparatus 2204 may further include means for receiving minimum system information from the one or more radio nodes indicating the service ID of the system information service. The apparatus 2204 may further include means for exchanging communication via the wireless network based on the system information associated with the system information service. The apparatus 2204 may further include means for performing any of the aspects described in connection with the flowchart in FIG. 17 or performed by the UE in any of FIGS. 12-16. The means may be the component 198 of the apparatus 2204 configured to perform the functions recited by the means. As described supra, the apparatus 2204 may include the TX processor 468, the RX processor 456, and the controller/processor 459. As such, in one configuration, the means may be the TX processor 468, the RX processor 456, and/or the controller/processor 459 configured to perform the functions recited by the means.

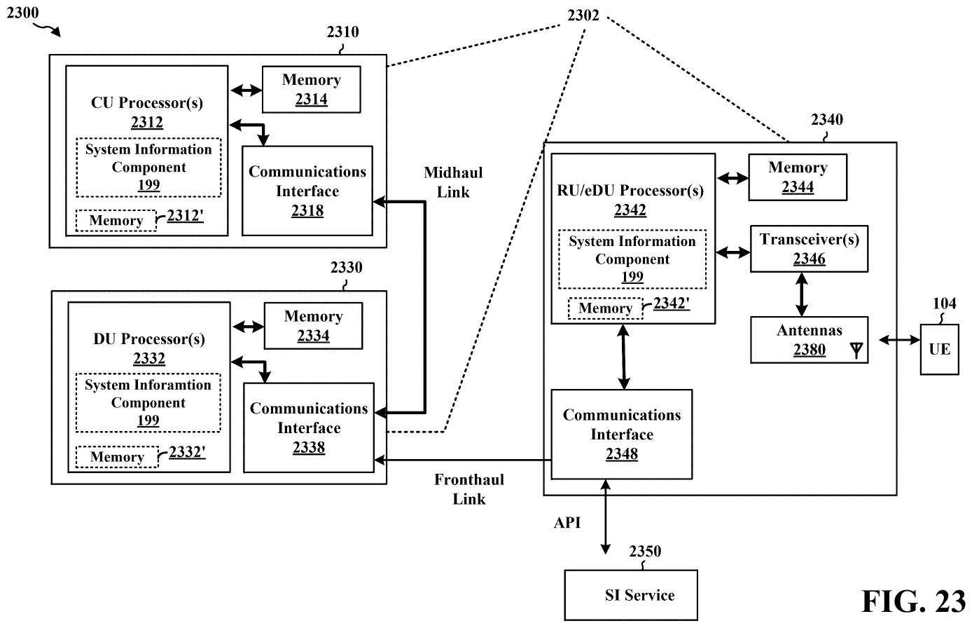

FIG. 23 is a diagram 2300 illustrating an example of a hardware implementation for a network entity 2302. The network entity 2302 may be a BS, a component of a BS, or may implement BS functionality. The network entity 2302 may include at least one of a CU 2310, a DU 2330, or an eDU or an RU, which may be referred to as a radio node 2340. For example, depending on the layer functionality handled by the component 199, the network entity 2302 may include the CU 2310; both the CU 2310 and the DU 2330; each of the CU 2310, the DU 2330, and the RU; the DU 2330; both the DU 2330 and the RU; or the RU. The CU 2310 may include at least one CU processor 2312. The CU processor(s) 2312 (or processor circuitry) may include on-chip memory 2312′. In some aspects, the CU 2310 may further include additional memory modules 2314 and a communications interface 2318. The CU 2310 communicates with the DU 2330 through a midhaul link, such as an F1 interface. The DU 2330 may include at least one DU processor 2332. The DU processor(s) 2332 (or processor circuitry) may include on-chip memory 2332′. In some aspects, the DU 2330 may further include additional memory modules 2334 and a communications interface 2338. The DU 2330 communicates with the RU, eDU, or radio node 2340 through a fronthaul link. The radio node 2340 may include at least one processor 2342. The processor(s) 2342 (or processor circuitry) may include on-chip memory 2342′. In some aspects, the radio node 2340 may further include additional memory modules 2344, one or more transceivers 2346, antennas 2380, and a communications interface 2348. The radio node 2340 communicates with the UE 104. As described herein, the radio node, e.g., such as an eDU, may obtain SI from an SI service 2350 using an API. The on-chip memory 2312′, 2332′, 2342′ and the additional memory modules 2314, 2334, 2344 may each be considered a computer-readable medium/memory. Each computer-readable medium/memory may be non-transitory. Each of the processors 2312, 2332, 2342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the system information component 199 may be configured to obtain a request for system information for a UE; provide the request for the system information to a system information service for a wireless network; receive the system information from the system information service in response to providing the request; and provide the system information from the system information service for the UE. The system information component 199 may be configured to provide, prior to the request, initial system information that indicates a service identifier for the system information service and a delivery mode for the system information. The system information component 199 may be configured to obtain system information from a system information service; obtain a request for the system information (e.g., for a UE); and provide the system information, for the UE, in response to the request, wherein the system information is obtained from the system information service prior to the request. The system information component 199 may be further configured to perform any of the aspects described in connection with the flowcharts in FIGS. 18 and/or 19, and/or any of the aspects performed by or in connection with the eDU 1202, 1302, 1402, 1502, 1602 or ACMS 1408 in any of FIGS. 12-16. The system information component 199 may be within one or more processors of one or more of the CU 2310, DU 2330, and the radio node 2340. The system information component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2302 may include a variety of components configured for various functions. In one configuration, the network entity 2302 may include means for means for obtaining a request for system information from a user equipment (UE); means for providing the request for the system information to a system information service for a wireless network; means for receiving the system information from the system information service in response to providing the request; and means for providing the system information from the system information service for the UE. The network entity 2302 may include means for providing, prior to the request, initial system information that indicates a service identifier for the system information service and a delivery mode for the system information. The network entity 2302 may include means for obtaining system information from a system information service; means for obtaining a request for the system information (e.g., for/from a UE); and means for providing the system information, for the UE, in response to the request, wherein the system information is obtained from the system information service prior to the request. The network entity 2302 may further include means for performing any of the aspects described in connection with the flowcharts in FIGS. 18 and/or 19, and/or any of the aspects performed by or in connection with the eDU 1202, 1302, 1402, 1502, 1602 or ACMS 1408 in any of FIGS. 12-16. The means may be the component 199 of the network entity 2302 configured to perform the functions recited by the means. As described supra, the network entity 2302 may include the TX processor 416, the RX processor 470, and the controller/processor 475. As such, in one configuration, the means may be the TX processor 416, the RX processor 470, and/or the controller/processor 475 configured to perform the functions recited by the means.

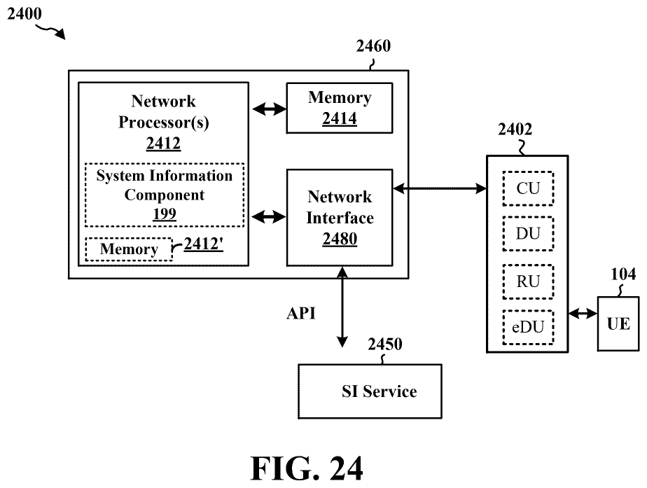

FIG. 24 is a diagram 2400 illustrating an example of a hardware implementation for a network entity 2460. In some aspects, the network entity 2460 may be a core network service such as an ACMS 1408, among other examples. In one example, the network entity 2460 may be within the core network having a service based architecture as described herein. The network entity 2460 may include at least one network processor 2412 (or processor circuitry). The network processor(s) 2412 may include on-chip memory 2412′ (or memory circuitry). In some aspects, the network entity 2460 may further include additional memory modules 2414. The network entity 2460 communicates via the network interface 2480 directly (e.g., backhaul link) or indirectly (e.g., through a RIC) with the radio node 2402. The network entity 2460 may also communicate with an SI service 2450, e.g., based on API. The on-chip memory 2412′ and the additional memory modules 2414 may each be considered a computer-readable medium/memory. Each computer-readable medium/memory may be non-transitory. The network processor(s) 2412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the system information component 199 may be configured to obtain a request for system information for a UE; provide the request for the system information to a system information service for a wireless network; receive the system information from the system information service in response to providing the request; and provide the system information from the system information service for the UE. The system information component 199 may be configured to provide, prior to the request, initial system information that indicates a service identifier for the system information service and a delivery mode for the system information. The system information component 199 may be configured to obtain system information from a system information service; obtain a request for the system information (e.g., for/from a UE); and provide the system information, for the UE, in response to the request, wherein the system information is obtained from the system information service prior to the request. The system information component 199 may be further configured to perform any of the aspects described in connection with the flowcharts in FIGS. 18 and/or 19, and/or any of the aspects performed by or in connection with the eDU 1202, 1302, 1402, 1502, 1602 or ACMS 1408 in any of FIGS. 12-16. The system information component 199 may be within one or more processors of one or more of the CU 2310, DU 2330, and the radio node 2340. The system information component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2302 may include a variety of components configured for various functions. The network entity 2460 may include a variety of components configured for various functions. In one configuration, the network entity 2460 may include means for means for obtaining a request for system information from a user equipment (UE); means for providing the request for the system information to a system information service for a wireless network; means for receiving the system information from the system information service in response to providing the request; and means for providing the system information from the system information service for the UE. The network entity 2302 may include means for providing, prior to the request, initial system information that indicates a service identifier for the system information service and a delivery mode for the system information. The network entity 2302 may include means for obtaining system information from a system information service; means for obtaining a request for the system information (e.g., for/from a UE); and means for providing the system information, for the UE, in response to the request, wherein the system information is obtained from the system information service prior to the request. The network entity 2302 may further include means for performing any of the aspects described in connection with the flowcharts in FIGS. 18 and/or 19, and/or any of the aspects performed by or in connection with the eDU 1202, 1302, 1402, 1502, 1602 or ACMS 1408 in any of FIGS. 12-16. The means may be the system information component 191 of the network entity 2460 configured to perform the functions recited by the means.

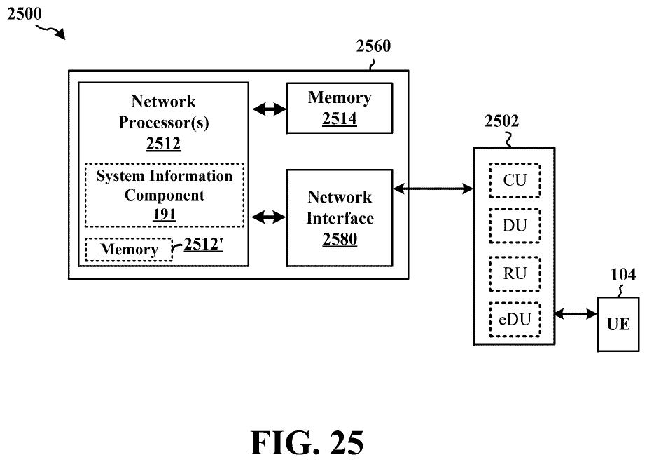

FIG. 25 is a diagram 2500 illustrating an example of a hardware implementation for a network entity 2560. In some aspects, the network entity 2560 may be an SI service, e.g., 1206, 1306, 1406, 1506, 1606, among other examples. In one example, the network entity 2560 may be within the core network as part of a service based architecture, as described herein. The network entity 2560 may include at least one network processor 2512 (or processor circuitry). The network processor(s) 2512 may include on-chip memory 2512′ (or memory circuitry). In some aspects, the network entity 2560 may further include additional memory modules 2514. The network entity 2560 communicates via the network interface 2580 directly (e.g., backhaul link) or indirectly (e.g., through a RIC) with the radio node 2502. The on-chip memory 2512′ and the additional memory modules 2514 may each be considered a computer-readable medium/memory. Each computer-readable medium/memory may be non-transitory. The network processor(s) 2512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the system information component 191 may be configured to receive a request for system information for a UE served by a network node; and provide the system information to the network node serving the UE in response to the request. The system information component 191 may be configured to obtain the system information from one or more of a service of the wireless network or a radio node for the wireless network. The system information component 191 may be configured to perform at least one of an authorization or authentication for the UE with an authorization service prior to providing the system information to the serving radio node in response to the request. The system information component 191 may be configured to perform at least one of an authorization or authentication for the UE with an authorization service prior to providing the system information to the ACMS in response to the request. The system information component 191 may be configured to obtain system information from one or more of a service for the wireless network or a radio node for the wireless network; and provide the system information from the system information service to one or more network nodes. The system information component 191 may be configured to provide, to the radio node, schedule information for the system information to be acquired from the radio node. The system information component 191 may be further configured to perform any of the aspects described in connection with the flowcharts in FIGS. 20 and/or 21, and/or any of the aspects performed by or in connection with the SI service 1206, 1306, 1406, 1506, 1606 in any of FIGS. 12-16. The system information component 191 may be within the network processor(s) 2512. The system information component 191 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2560 may include a variety of components configured for various functions. In one configuration, the network entity 2560 may include means for receiving a request for system information for a user equipment (UE) served by a network node; and means for providing the system information to the network node serving the UE in response to the request. The network entity 2560 may include means for obtaining the system information from one or more of a service of the wireless network or a radio node for the wireless network. The network entity 2560 may include means for performing at least one of an authorization or authentication for the UE with an authorization service prior to providing the system information to the serving radio node in response to the request. The network entity 2560 may include means for performing at least one of an authorization or authentication for the UE with an authorization service prior to providing the system information to the ACMS in response to the request. The network entity 2560 may include means for obtaining system information from one or more of a service for the wireless network or a radio node for the wireless network; and means for providing the system information from the system information service to one or more network nodes. The network entity 2560 may include means for providing, to the radio node, schedule information for the system information to be acquired from the radio node. The network entity 2560 may further include means for performing any of the aspects described in connection with the flowcharts in FIGS. 20 and/or 21, and/or any of the aspects performed by or in connection with the SI service 1206, 1306, 1406, 1506, 1606 in any of FIGS. 12-16. The means may be the system information component 191 of the network entity 2560 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: transmitting, to a network node, a request for system information associated with a system information service for a wireless network; and receiving, via the network node, the system information from the system information service for the wireless network.

Aspect 2 is the method of aspect 1, further comprising: receiving, prior to transmitting the request, initial system information that indicates a service identifier for the system information service and a delivery mode for the system information.

Aspect 3 is the method of aspect 1 or aspect 2, wherein the initial system information indicates the delivery mode for the system information based on one or more of: broadcast, on-demand download, download over a user plane, download for each system information or system information block (SIB), download from the system information service, download via a radio node, or download via an access connection management service (ACMS).

Aspect 4 is the method of any of aspects 1-3, wherein the request from the UE comprises a first internet protocol (IP) packet including a source IP address of the UE and a destination IP address of the system information service, and wherein the system information is received in a second IP packet that encapsulates the system information.

Aspect 5 is the method of aspect 4, further comprising: establishing a protocol data unit (PDU) session prior to the request.

Aspect 6 is the method of aspect 4 or 5, further comprising: obtaining routing information for the system information service from one or more of: a discovery service, previously configured SI routing information, or minimum system information.

Aspect 7 is the method of aspect 4 or 5, further comprising: obtaining routing information for the system information service from a discovery service.

Aspect 8 is the method of aspect 4 or 5, further comprising: obtaining routing information for the system information service from configured SI routing information.

Aspect 9 is the method of aspect 4 or 5, further comprising: obtaining routing information for the system information service from minimum system information.

Aspect 10 is the method of any of aspects 1-9, further comprising: generating a fully qualified domain name (FQDN) for the system information service based on one or more of a public land mobile network identifier (PLMN ID), a tracking area code (TAC), and a service identifier (ID) for the system information service.

Aspect 11 is the method of any of aspects 1-10, wherein the request from the UE is directed to one or more radio nodes and comprises one or more of: a first identifier (ID) of the UE, a service ID of the system information service, or a system information index.

Aspect 12 is the method of any of aspects 1-11, further comprising: receiving minimum system information from the one or more radio nodes indicating the service ID of the system information service.

Aspect 13 is the method of any of aspects 1-11, wherein the system information is in a message or a system information container from a radio node.

Aspect 14 is the method of any of aspects 1-11, wherein the request is in a first random access message, and the system information is comprised in a second random access message.

Aspect 15 is the method of clause any of aspects 1-4, wherein the request from the UE is comprised in a first non-access stratum (NAS) message directed to an access connection management service (ACMS) and indicates a system information index, and wherein the system information is received in a second NAS message from the ACMS that encapsulates the system information indicated by the system information index.

Aspect 16 is the method of clause any of aspects 1-4, wherein the request from the UE is comprised in a first non-access stratum (NAS) message directed to an access connection management service (ACMS) and indicates a system information index.

Aspect 17 is the method of clause any of aspects 1-4, wherein the system information is received in a second NAS message from the ACMS that encapsulates the system information indicated by the system information index.

Aspect 18 is the method of clause any of aspects 1-4, wherein the request from the UE is comprised in a first protocol data unit (PDU) directed to a radio node, and wherein the system information is received in a second PDU from the radio node.

Aspect 19 is the method of any of aspects 1-4 or 18, wherein the UE has an access connection with the radio node, wherein the request is comprised in a layer 2 (L2) PDU to the radio node, and wherein the system information is comprised in a response L2 PDU from the radio node.

Aspect 20 is the method of any of aspects 1-4 or 18, wherein the UE does not have an established connection with the radio node, and the request is comprised in a system information block (SIB) or system information (SI) request PDU to the radio node, and the system information is comprised in a layer 2 (L2) PDU from the radio node.

Aspect 21 is the method of any of aspects 1-20, further comprising: exchanging communication via the wireless network based on the system information associated with the system information service.

Aspect 22 is a method of wireless communication at a network node, comprising: obtaining a request for system information from a user equipment (UE); providing the request for the system information to a system information service for a wireless network; receiving the system information from the system information service in response to providing the request; and providing the system information from the system information service for the UE.

Aspect 23 is the method of aspect 22, further comprising: providing, prior to the request, initial system information that indicates a service identifier for the system information service and a delivery mode for the system information.

Aspect 24 is the method of aspect 22 or 23, wherein the request for the UE comprises a first internet protocol (IP) packet including a source IP address of the UE and a destination IP address of the system information service, and wherein the system information is in a second IP packet that encapsulates the system information, wherein providing the request to the system information service includes providing the first IP packet to the system information service.

Aspect 25 is the method of aspect 22 or 23, wherein the request for the UE comprises a first internet protocol (IP) packet including a source IP address of the UE and a destination IP address of the system information service, and wherein the system information is in a second IP packet that encapsulates the system information.

Aspect 26 is the method of aspect 22 or 23, wherein the system information is in a second IP packet that encapsulates the system information, wherein providing the request to the system information service includes providing the first IP packet to the system information service.

Aspect 27 is the method of aspect 22 or 23, wherein the network node is a radio node, and wherein the request for the UE is directed to the radio node and comprises one or more of: a UE identifier (ID) of the UE, a service ID of the system information service, or a system information index, wherein providing the request for the system information to the system information service includes sending an additional request to the system information service indicating one or more of the UE ID or the system information index.

Aspect 28 is the method of aspect 22 or 23, wherein the network node is a radio node, and wherein the request for the UE is directed to the radio node and comprises one or more of: a UE identifier (ID) of the UE, a service ID of the system information service, or a system information index.

Aspect 29 is the method of aspect 22 or 23, wherein providing the request for the system information to the system information service includes sending an additional request to the system information service indicating one or more of the UE ID or the system information index.

Aspect 30 is the method of aspect 22 or 23, wherein the system information is in a message, a system information container, or a random access message from the radio node for the UE.

Aspect 31 is the method of aspect 22 or 23, wherein the network node comprises an access connection management service (ACMS), and wherein the request for the UE is comprised in a first non-access stratum (NAS) message directed to the ACMS and indicating a system information index, and the system information is provided in a second NAS message from the ACMS that encapsulates the system information indicated by the system information index.

Aspect 32 is the method of aspect 22 or 23, wherein the network node comprises an access connection management service (ACMS).

Aspect 33 is the method of aspect 22 or 23, wherein the request for the UE is comprised in a first non-access stratum (NAS) message directed to the ACMS and indicating a system information index.

Aspect 34 is the method of aspect 22 or 23, and the system information is provided in a second NAS message from the ACMS that encapsulates the system information indicated by the system information index.

Aspect 35 is a method of wireless communication at a network node, comprising: obtaining system information from a system information service; obtaining a request for the system information from a user equipment (UE); and providing the system information, for the UE, in response to the request, wherein the system information is obtained from the system information service prior to the request.

Aspect 36 is the method of aspect 35, wherein the network node is a radio node, and wherein the request for the UE is comprised in a first protocol data unit (PDU) directed to the radio node, and the system information is in a second PDU from the radio node for the UE.

Aspect 37 is the method of aspect 35, wherein the request for the UE is comprised in a first protocol data unit (PDU) directed to a radio node, and the system information is in a second PDU from the radio node for the UE.

Aspect 38 is the method of aspect 35, wherein the network node is a radio node, and the system information is in a second PDU from the radio node for the UE.

Aspect 39 is the method of aspect 35, wherein the radio node has a connection with the UE, and wherein the request is comprised in a layer 2 (L2) PDU to the radio node, and the system information is comprised in a response L2 PDU from the radio node.

Aspect 40 is the method of aspect 35, wherein the radio node has a connection with the UE, and wherein the request is comprised in a layer 2 (L2) PDU to the radio node.

Aspect 41 is the method of aspect 35, wherein the radio node has a connection with the UE and the system information is comprised in a response L2 PDU from the radio node.

Aspect 42 is the method of aspect 35, wherein the radio node does not have an established connection with the UE, and wherein the request is comprised in a system information block (SIB) or system information (SI) request PDU to the radio node, and the system information is comprised in a layer 2 (L2) PDU from the radio node.

Aspect 43 is the method of aspect 35, wherein the radio node does not have an established connection with the UE, and the system information is comprised in a layer 2 (L2) PDU from the radio node.

Aspect 44 is the method of aspect 35, wherein the radio node does not have an established connection with the UE, and wherein the request is comprised in a system information block (SIB) or system information (SI) request PDU to the radio node.

Aspect 45 is a method of wireless communication at a system information service for a wireless network, comprising: receiving a request for system information for a user equipment (UE) served by a network node; and providing the system information to the network node serving the UE in response to the request.

Aspect 46 is the method of aspect 45, further comprising: obtaining the system information from one or more of a service of the wireless network or a radio node for the wireless network.

Aspect 47 is the method of aspect 45 or 46, wherein the request is comprised in a first internet protocol (IP) packet for the UE and includes a source IP address of the UE and a destination IP address of the system information service, and wherein the system information is provided in a second IP packet to that encapsulates the system information from the system information service.

Aspect 48 is the method of aspect 45 or 46, wherein the request is comprised in a first internet protocol (IP) packet for the UE and includes a source IP address of the UE and a destination IP address of the system information service.

Aspect 49 is the method of aspect 45 or 46, wherein the system information is provided in a second IP packet to that encapsulates the system information from the system information service.

Aspect 50 is the method of aspect 45 or 46, wherein the network node is a serving radio node that is serving the UE, and wherein the request is from the serving radio node and comprises one or more of: a UE identifier (ID) of the UE, a service ID of the system information service, and a system information index.

Aspect 51 is the method of aspect 50, further comprising: performing at least one of an authorization or authentication for the UE with an authorization service prior to providing the system information to the serving radio node in response to the request.

Aspect 52 is the method of aspect 45 or 46, wherein the network node comprises an access connection management service (ACMS), wherein the request is from the ACMS and indicates a UE identifier.

Aspect 53 is the method of aspect 52, wherein the UE identifier is a subscription permanent identifier (SUPI) or a generic public subscriber identifier (GPSI).

Aspect 54 is the method of aspect 52 or 53, further comprising: performing at least one of an authorization or authentication for the UE with an authorization service prior to providing the system information to the ACMS in response to the request.

Aspect 55 is a method of wireless communication at a system information service for a wireless network, comprising: obtain system information from one or more of a service for the wireless network or a radio node for the wireless network; and providing the system information from the system information service to one or more network nodes.

Aspect 56 is the method of aspect 55, further comprising: providing, to the radio node, schedule information for the system information to be acquired from the radio node.

Aspect 57 is an apparatus for wireless communication at a UE, comprising: one or more memories; and one or more processors coupled to the one or more memories and configured to cause the UE to perform the method of any of aspects 1-21.

Aspect 58 is an apparatus for wireless communication at a UE, comprising means for performing each step in the method of any of aspects 1-21.

Aspect 59 is a UE comprising: a processing system that includes processor circuitry and memory circuitry that stores code and is coupled with the processor circuitry, the processing system configured to cause the UE to perform the method of any of aspects 1-21.

Aspect 60 is the apparatus of any of aspects 57 to 59, further comprising one or more transceivers or antennas configured to receive or to transmit in association with the method of any of aspects 1-21.

Aspect 61 is a computer-readable storage medium (e.g., a non-transitory computer-readable storage medium) storing computer executable code at a UE, the code when executed by at least one processor causes the UE to perform the method of any of aspects 1-21.

Aspect 62 is an apparatus for wireless communication at a UE, comprising: one or more memories; and one or more processors coupled to the one or more memories and configured to cause the UE to perform the method of any of aspects 22-34.

Aspect 63 is an apparatus for wireless communication at a UE, comprising means for performing each step in the method of any of aspects 22-34.

Aspect 64 is a UE comprising: a processing system that includes processor circuitry and memory circuitry that stores code and is coupled with the processor circuitry, the processing system configured to cause the UE to perform the method of any of aspects 22-34.

Aspect 66 is the apparatus of any of aspects 62 to 64, further comprising one or more transceivers or antennas configured to receive or to transmit in association with the method of any of aspects 22-34.

Aspect 66 is a computer-readable storage medium (e.g., a non-transitory computer-readable storage medium) storing computer executable code at a UE, the code when executed by at least one processor causes the UE to perform the method of any of aspects 22-34.

Aspect 67 an apparatus for wireless communication at a network node, comprising: one or more memories; and one or more processors coupled to the one or more memories and configured to cause the network node to perform the method of any of aspects 35-44.

Aspect 68 is an apparatus for wireless communication at a network node, comprising means for performing each step in the method of any of aspects 35-44.

Aspect 69 is network entity comprising: a processing system that includes processor circuitry and memory circuitry that stores code and is coupled with the processor circuitry, the processing system configured to cause the network entity to: perform the method of any of aspects 35-44.

Aspect 70 is the apparatus of any of aspects 67 to 69, further comprising one or more transceivers or antennas configured to receive or to transmit in association with the method of any of aspects 35-44.

Aspect 71 is a computer-readable storage medium (e.g., a non-transitory computer-readable storage medium) storing computer executable code at a network node, the code when executed by at least one processor causes the network node to perform the method of any of aspects 34-43.

Aspect 72 is an apparatus for wireless communication at a system information service, comprising: one or more memories; and one or more processors coupled to the one or more memories and configured to cause the system information service to perform the method of any of aspects 45-54.

Aspect 73 is an apparatus for wireless communication at a system information service, comprising means for performing each step in the method of any of aspects 45-54.

Aspect 74 is a system information service comprising: a processing system that includes processor circuitry and memory circuitry that stores code and is coupled with the processor circuitry, the processing system configured to cause the system information service to: perform the method of any of aspects 45-54.

Aspect 75 is the apparatus of any of aspects 72 to 74, further comprising one or more transceivers or antennas configured to receive or to transmit in association with the method of any of aspects 45-54.

Aspect 76 is a computer-readable storage medium (e.g., a non-transitory computer-readable storage medium) storing computer executable code at a system information service, the code when executed by at least one processor causes the system information service to perform the method of any of aspects 45-54.

Aspect 77 is an apparatus for wireless communication at a system information service, comprising: one or more memories; and one or more processors coupled to the one or more memories and configured to cause the system information service to perform the method of any of aspects 55-56.

Aspect 78 is an apparatus for wireless communication at a system information service, comprising means for performing each step in the method of any of aspects 55-56.

Aspect 79 is a system information service comprising: a processing system that includes processor circuitry and memory circuitry that stores code and is coupled with the processor circuitry, the processing system configured to cause the system information service to: perform the method of any of aspects 55-56.

Aspect 80 is the apparatus of any of aspects 77 to 79, further comprising one or more transceivers or antennas configured to receive or to transmit in association with the method of any of aspects 55-56.

Aspect 81 is a computer-readable storage medium (e.g., a non-transitory computer-readable storage medium) storing computer executable code at a system information service, the code when executed by at least one processor causes the system information service to perform the method of any of aspects 55-56.

1. An apparatus for wireless communication at a user equipment (UE), comprising:
one or more memories; and
one or more processors coupled to the one or more memories and configured to cause the UE to:
transmit, to a network node, a request for system information associated with a system information service for a wireless network; and
receive, via the network node, the system information from the system information service for the wireless network.

2. The apparatus of claim 1, further comprising at least one antenna coupled to the one or more processors, wherein the one or more processors are further configured to cause the UE to:
receive, prior to transmission of the request, initial system information that indicates a service identifier for the system information service and a delivery mode for the system information.

3. The apparatus of claim 2, wherein the initial system information indicates the delivery mode for the system information based on one or more of:
broadcast,
on-demand download,
download over a user plane,
download for each system information or system information block (SIB),
download from the system information service,
download via a radio node, or
download via an access connection management service (ACMS).

4. The apparatus of claim 1, wherein the request from the UE comprises a first internet protocol (IP) packet that includes a source IP address of the UE and a destination IP address of the system information service, and wherein the system information is in a second IP packet for the UE.

5. The apparatus of claim 4, wherein the one or more processors are further configured to cause the UE to:
establish a protocol data unit (PDU) session prior to the request.

6. The apparatus of claim 4, wherein the one or more processors are further configured to cause the UE to:
obtain routing information for the system information service from one or more of:
a discovery service,
previously configured SI routing information, or
minimum system information.

7. (canceled)

8. The apparatus of claim 1, wherein the request from the UE is directed to one or more radio nodes and comprises one or more of:
a first identifier (ID) of the UE,
a service ID of the system information service, or
a system information index.

9. (canceled)

10. (canceled)

11. (canceled)

12. The apparatus of claim 1, wherein the request from the UE is comprised in a first non-access stratum (NAS) message directed to an access connection management service (ACMS) and indicates a system information index, and wherein the system information is in a second NAS message from the ACMS that encapsulates the system information indicated by the system information index.

13. The apparatus of claim 1, wherein the request from the UE is comprised in a first protocol data unit (PDU) directed to a radio node, and wherein the system information is in a second PDU from the radio node.

14. The apparatus of claim 13, wherein the UE has an access connection with the radio node, wherein the request is comprised in a layer 2 (L2) PDU to the radio node, and wherein the system information is comprised in a response L2 PDU from the radio node.

15. (canceled)

16. The apparatus of claim 1, wherein the one or more processors are further configured to cause the UE to:
exchange communication via the wireless network based on the system information associated with the system information service.

17. An apparatus for wireless communication at a network node, comprising:
one or more memories; and
one or more processors coupled to the one or more memories and configured to cause the network node to:
obtain a request for system information for a user equipment (UE);
provide the request for the system information to a system information service for a wireless network;
receive the system information from the system information service in response to the request; and
provide the system information from the system information service for the UE.

18. The apparatus of claim 17, further comprising one or more antennas coupled to the one or more processors, wherein the one or more processors are further configured to cause the network node to:
provide, prior to the request, initial system information that indicates a service identifier for the system information service and a delivery mode for the system information.

19. The apparatus of claim 17, wherein the request for the UE comprises a first internet protocol (IP) packet including a source IP address of the UE and a destination IP address of the system information service, wherein the system information is in a second IP packet that encapsulates the system information, and
wherein to provide the request to the system information service, the one or more processors are configured to cause the network node to provide the first IP packet to the system information service.

20. The apparatus of claim 17, wherein the network node is a radio node, and wherein the request for the UE is directed to the radio node and comprises one or more of:
a UE identifier (ID) of the UE,
a service ID of the system information service, or
a system information index,
wherein to provide the request for the system information to the system information service, the one or more processors are configured to cause the network node to send an additional request to the system information service that indicates one or more of the UE ID or the system information index.

21. (canceled)

22. The apparatus of claim 17, wherein the network node comprises an access connection management service (ACMS), wherein the request for the UE is comprised in a first non-access stratum (NAS) message directed to the ACMS that indicates a system information index, and wherein the system information is provided in a second NAS message from the ACMS that encapsulates the system information indicated by the system information index.

23. An apparatus for wireless communication at a network node, comprising:
one or more memories; and
one or more processors coupled to the one or more memories and configured to cause the network node to:
obtain system information from a system information service;
obtain a request for the system information for a user equipment (UE); and
provide the system information, for the UE, in response to the request, wherein the system information is obtained from the system information service prior to the request.

24. The apparatus of claim 23, wherein the network node is a radio node, wherein the request for the UE is comprised in a first protocol data unit (PDU) directed to the radio node, and wherein the system information is in a second PDU from the radio node for the UE.

25. The apparatus of claim 24, wherein the radio node has a connection with the UE, wherein the request is comprised in a layer 2 (L2) PDU to the radio node, and wherein the system information is comprised in a response L2 PDU from the radio node.

26. The apparatus of claim 24, wherein the radio node does not have an established connection with the UE, wherein the request is comprised in a system information block (SIB) or system information (SI) request PDU to the radio node, and wherein the system information is comprised in a layer 2 (L2) PDU from the radio node.

27.-36. (canceled)
